(19) United States
(12) Patent Application Publication
(10) Pub. No.: US 2004/0087436 A1
(43) Pub. Date: May 6, 2004

(54) Novel polymerisation catalysts

(76) Inventors: Vernon Charles Gibson, London (GB); Simon Michael Green, Surrey (GB); David John Jones, London (GB)

Correspondence Address: Finnegan Henderson Farabow, Garrett & Dunner, 1300 I Street NW, Washington, DC, 20005-3315, US

(21) Appl. No.: 10/450,911

(22) PCT Filed: Dec. 19, 2001
(86) PCT No.: PCT/GB01/05660

(30) Foreign Application Priority Data
Dec. 20, 2000 (GB) 0031135.7
Sep. 24, 2001 (GB) 0122950.9

(51) Int. Cl. B01J 31/00; C07F 15/00

(52) U.S. Cl. 502/150; 502/162; 502/167; 546/2; 556/13; 556/32

(57) ABSTRACT

Novel complexes having the formula (I) are disclosed, wherein M is a Group 6 metal and T is its oxidation state; X represents an atom or group covalenty or ionically bonded to M; b is the valency of the atom or group X; L is a group datively bound to M, and n is from 0 to 4; Z is oxygen or sulphur; A¹ to A³ are each independently N or P or CR, with the provisio that at least one is CR; R¹ is a polycyclic hydrocarbyl group; Q is CR⁵, PR⁵R⁵ or N; each R and R⁵ to R⁷ are all independently selected from hydrogen, halogen, hydrocarbyl, substituted hydrocarbyl, heterohydrocarbyl or SiR′₃ where each R′ is independently selected from hydrogen, halogen, hydrocarbyl, substituted hydrocarbyl, heterohydrocarbyl, substituted heterohydrocarbyl, and any two or more of each R and R⁵ to R⁷ may be linked to form cyclic substituents. These complexes have utility as catalysts for the polymerisation of 1-olefins.

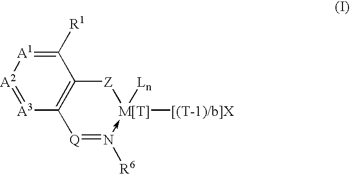

The present invention relates to novel polymerisation catalysts based on organic transition metal complexes and to a polymerisation process using the catalysts.

The use of certain transition metal compounds to polymerise I-olefins, for example, ethylene, is well established in the prior art. The use of Ziegler-Natta catalysts, for example, those catalysts produced by activating titanium halides with organometallic compounds such as triethylaluminium, is fundamental to many commercial processes for manufacturing polyolefins. Over the last twenty or thirty years, advances in the technology have led to the development of Ziegler-Natta catalysts which have such high activities that olefin polymers and copolymers containing very low concentrations of residual catalyst can be produced directly in commercial polymerisation processes. The quantities of residual catalyst remaining in the produced polymer are so small as to render unnecessary their separation and removal for most commercial applications. Such processes can be operated by polymerising the monomers in the gas phase, or in solution or in suspension in a liquid hydrocarbon diluent. Polymerisation of the monomers can be carried out in the gas phase (the “gas phase process”), for example by fluidising under polymerisation conditions a bed comprising the target polyolefin powder and particles of the desired catalyst using a fluidising gas stream comprising the gaseous monomer. In the so-called “solution process” the (co)polymerisation is conducted by introducing the monomer into a solution or suspension of the catalyst in a liquid hydrocarbon diluent under conditions of temperature and pressure such that the produced polyolefin forms as a solution in the hydrocarbon diluent. In the “slurry process” the temperature, pressure and choice of diluent are such that the produced polymer forms as a suspension in the liquid hydrocarbon diluent. These processes are generally operated at relatively low pressures (for example 10-50 bar) and low temperature (for example 50 to 150° C.).

Commodity polyethylenes are commercially produced in a variety of different types and grades. Homopolymerisation of ethylene with transition metal based catalysts leads to the production of so-called “high density” grades of polyethylene. These polymers have relatively high stiffness and are useful for making articles where inherent rigidity is required. Copolymerisation of ethylene with higher 1-olefins (e.g. butene, hexene or octene) is employed commercially to provide a wide variety of copolymers differing in density and in other important physical properties. Particularly important copolymers made by copolymerising ethylene with higher 1-olefins using transition metal based catalysts are the copolymers having a density in the range of 0.91 to 0.93. These copolymers which are generally referred to in the art as “linear low density polyethylene” are in many respects similar to the so called “low density” polyethylene produced by the high pressure free radical catalysed polymerisation of ethylene. Such polymers and copolymers are used extensively in the manufacture of flexible blown film.

An important feature of the microstructure of the copolymers of ethylene and higher 1-olefins is the manner in which polymerised comonomer units are distributed along the “backbone” chain of polymerised ethylene units. The conventional Ziegler-Natta catalysts have tended to produce copolymers wherein the polymerised comonomer units are clumped together along the chain. To achieve especially desirable film properties from such copolymers the comonomer units in each copolymer molecule are preferably not clumped together, but are well spaced along the length of each linear polyethylene chain. In recent years the use of certain metallocene catalysts (for example biscyclopentadienylzirconiumdichloride activated with alumoxane) has provided catalysts with potentially high activity and capable of providing an improved distribution of the comonomer units. However, metallocene catalysts of this type suffer from a number of disadvantages, for example, high sensitivity to impurities when used with commercially available monomers, diluents and process gas streams, the need to use large quantities of expensive alumoxanes to achieve high activity, and difficulties in putting the catalyst on to a suitable support.

Complexes of chromium with nitrogen-containing or nitrogen and oxygen-containing organic compounds are known in the art. For example, K Folting et al in Chemical Communications, 1968, page 1170 et seq. disclose a methanol adduct of tris(8-quinolinato)-chromium(III); R F Bryan et al in Inorganic Chemistry Vol. 10, No. 7 at page 1468 et seq. disclose tris(glycinato)chromium(III) monohydrate; T J Collins et al in J. Chem. Soc., Chem. Commun., 1983 at page 681 disclose 1,2-bis(3,5-dichloro-2-hydroxybenzamido)ethane of chromium(III); F E Hahn et al in J. Am. Chem. Soc., 1990 112 at page 1854 et seq. disclose diastereomeric Cr(III) and Co(III) complexes of desferriferrithiocin; D M Stearns et al in Inorg. Chem. 1992, 31, page 5178 et seq. disclose chromium(III)picolinate complexes; S Hao et al in Inorganica Chimica Acta.213, 1993 at page 65 et seq. disclose cyclohexylamidinate derivatives of chromium(II); and I C Chisem et al in Chem. Commun. 1998 at page 1949 et seq disclose the preparation of certain Schiff-base chromium complexes. However, none of these references discloses the preparation of active polymerisation catalysts based on the chromium complexes.

WO 98/42664 discloses as polymerisation catalysts compounds having the general Formula (0) shown below in which M is a transition metal not including Cr, R¹ may be anthracenyl, and R⁶ may be an alkyl or aromatic group. Our own WO 99/19335 discloses such compounds where M is Cr, R¹ is t-Bu, and R⁶ may be an aromatic group. WO 00/50470 discloses a ligand having the same general formula where R¹ is anthracenyl, and R⁶ is a pyrrole group, for complexing with a Group 8-10 transition metal. Copending application WO 01/44324 discloses such compounds where M is a Group 3 to Group 10 transition metal such as Ni, Pd, Zt, Ti or Cr, R¹ is hydrocarbyl such as t-Bu, and R⁶ is a moiety containing an N, O, P or S atom which additionally links to M.

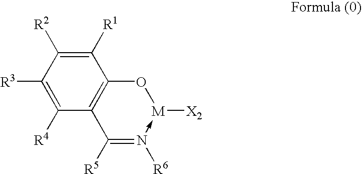

An object of the present invention is to provide a novel catalyst suitable for polymerising olefins, and especially for polymerising ethylene alone or for copolymerising ethylene with higher 1-olefins. A further object of the invention is to provide an improved process for the polymerisation of olefins, especially of ethylene alone or the copolymerisation of ethylene with higher 1-olefins to provide homopolymers and copolymers having controllable molecular weights. For example, using the catalyst of the present invention there can be made a wide variety of polyolefins such as, for example, liquid polyolefins, resinous or tacky polyolefins, solid polyolefins suitable for making flexible film and solid polyolefins having high stiffness.

We have discovered a class of novel Group 6 metal complexes which have unexpectedly good activity as olefin polymerisation catalysts.

In a first aspect the present invention provides a complex having the formula (I)

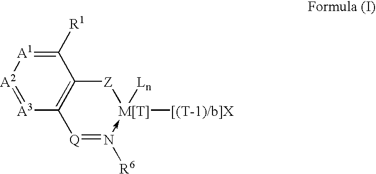

wherein M is a Group 6 metal and T is its oxidation state; X represents an atom or group covalently or ionically bonded to M; b is the valency of the atom or group X; L is a group datively bound to M, and n is from 0 to 4; Z is oxygen or sulphur; A¹ to A³ are each independently N or P or CR, with the proviso that at least one is CR; R¹ is a polycyclic hydrocarbyl group; Q is CR⁵, PR⁵R⁷ or N; each R and R⁵ to R⁷ are all independently selected from hydrogen, halogen, amino, hydrocarbyl, substituted hydrocarbyl, heterohydrocarbyl, substituted heterohydrocarbyl or SiR′₃ where each R′ is independently selected from hydrogen, halogen, hydrocarbyl, substituted hydrocarbyl, heterohydrocarbyl, substituted heterohydrocarbyl, and any two or more of each R and R⁵ to R⁷ may be linked to form cyclic substituents.

Preferably the complex of the invention has the formula (II)

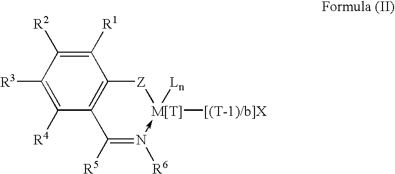

wherein R¹, R⁵, R⁶, M, T, L, n, b, X and Z are as defined above, and R² to R⁴ are each independently selected from hydrogen, halogen, hydrocarbyl, substituted hydrocarbyl, heterohydrocarbyl, substituted heterohydrocarbyl or SiR′₃ where each R′ is independently selected from hydrogen, halogen, hydrocarbyl, substituted hydrocarbyl, heterohydrocarbyl, substituted heterohydrocarbyl, and any two or more of R² to R⁶ may be linked to form cyclic substituents.

Preferably M is Cr, more preferably Cr(III).

Preferably R¹ is anthracenyl, naphthyl or triptycenyl, all of which may optionally be substituted, preferably with C₁-C₆ alkyl groups. Also preferred for the group R¹ are the following Structures A or B:

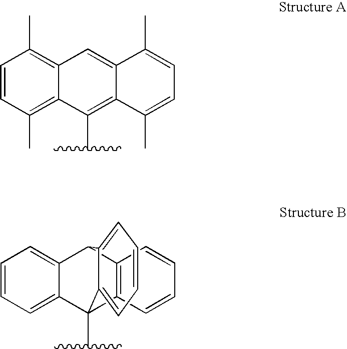

A further aspect of the invention encompasses the above-defined novel ligands. This aspect provides a compound having the formula (III)

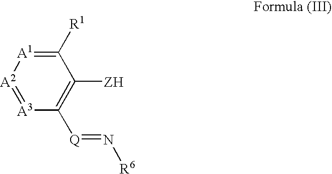

wherein Z is oxygen or sulphur; A¹ to A³ are each independently N or P or CR, with the proviso that at least one is CR; Q is CR⁵, PR⁵R⁷ or N; each R and R⁵ to R⁷ are all independently selected from hydrogen, halogen, hydrocarbyl, substituted hydrocarbyl, heterohydrocarbyl, substituted heterohydrocarbyl or SiR′₃ where each R′ is independently selected from hydrogen, halogen, hydrocarbyl, substituted hydrocarbyl, heterohydrocarbyl, substituted heterohydrocarbyl, and any two or more of each R and R⁵ to R⁷ may be linked to form cyclic substituents; and R¹ has the structure B:

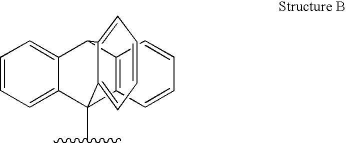

The invention also encompasses within its scope the novel precursors of such ligands, and accordingly a further aspect is a compound having the formula (V)

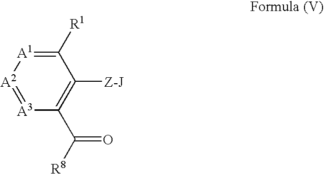

wherein Z is oxygen or sulphur; J is H or an alkali metal; A¹ to A³ are each independently N or P or CR, with the proviso that at least one is CR; R⁸ is selected from hydrogen, halogen, hydrocarbyl, substituted hydrocarbyl, heterohydrocarbyl, substituted heterohydrocarbyl or SiR′₃ where each R′ is independently selected from hydrogen, halogen, hydrocarbyl, substituted hydrocarbyl, heterohydrocarbyl and substituted heterohydrocarbyl; and R¹ has the structure B:

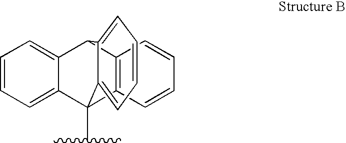

In one embodiment of all aspects of the invention, R⁶ is C₁-C₆ alkyl or alkenyl, particularly isopropyl. Other examples include cyclopropyl, cyclobutyl, cyclopentyl and cyclohexyl; t-butyl; —CH₂CH₂═CH₂; and —CH₂CH(CH₃)₂. Alternatively R⁶ may be C₁-C₆ haloalkyl or haloalkenyl, such as —CH₂C₃F₇.

In another embodiment R⁶ is C₁-C₂₄, preferably C₁-C₁₂ aryl, aralkyl or alkaryl, or at least partly halogenated analogues thereof. Examples include —Ph, —CH₂Ph, —C₂H₅Ph, —C₃H₇Ph, —CH₂Ph(o-CF₃), —CH₂Ph(p-t-Bu), —C₂H₅CH(Ph)₃, —Ph(2,4,6-Pb₃), and

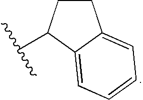

In addition to being halogenated, in this embodiment R⁶ may optionally be substituted with functional groups such as alkoxy, amino, nitro and the like. An example is —CH₂Ph(3,5-(OMe)₂).

Alternatively R⁶ is an amino group, optionally substituted. This includes embodiments where the nitrogen forms part of a heterocyclic ring, such as a pyridyl or pyrrole ring. An example is

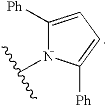

In another embodiment R⁶ is —R″-D-R⁸R⁹, where R″ is an optionally substituted hydrocarbyl bridging group, D is N, S, P or O, and R⁸ and R⁹ are each independently selected from hydrogen, halogen, hydrocarbyl, substituted hydrocarbyl, heterohydrocarbyl, substituted heterohydrocarbyl or SiR′₃ where each R′ is independently selected from hydrogen, halogen, hydrocarbyl, substituted hydrocarbyl, heterohydrocarbyl, substituted heterohydrocarbyl, and any two or more of the substituents on R″ and R⁸ or R⁹ may be linked to form cyclic substituents, as may any of the substituents on R″ and R⁵, with the proviso that if D is attached to R″ or R⁸ via a double bond or is O or S, R⁹ does not exist. In this embodiment D may be linked to M, thereby making the complex tridentate. Preferably D is N; in such a case, in a preferred structure D forms part of a pyridinyl ring.

Preferred structures for R⁶ include the following:

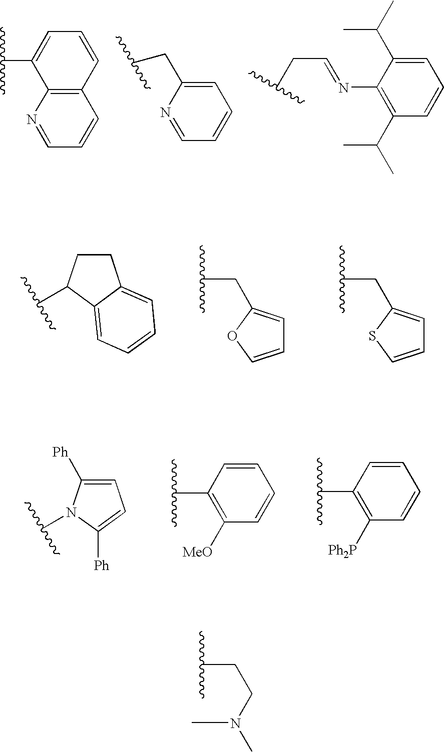

In one embodiment, when R⁶ is —R″-D-R⁸R⁹, R⁵ may be joined to a substituent on R″ to form a heterocyclic ring containing the N between R⁵ and R″, such as a pyridyl ring.

In an alternative embodiment, R² to R⁵ are all hydrogen.

In a preferred compound of Formula (II), M is Cr(III), Z is oxygen, R¹ is Structure A, R² to R⁵ are all hydrogen, R⁶ is isopropyl, X is Cl (of which there are therefore two), L is tetrahydrofuran, and n is 3.

The atom or group represented by X in the compounds of Formula (I) or (II) can be, for example, selected from halide, sulphate, nitrate, thiolate, thiocarboxylate, BF₄⁻, PF₆⁻, hydride, hydrocarbyloxide, carboxylate, hydrocarbyl, substituted hydrocarbyl and heterohydrocarbyl, or β-diketonates. Examples of such atoms or groups are chloride, bromide, methyl, ethyl, propyl, butyl, octyl, decyl, phenyl, benzyl, methoxide, ethoxide, isopropoxide, tosylate, triflate, formate, acetate, phenoxide and benzoate. Preferred examples of the atom or group X are halide, for example, chloride, bromide; hydride; hydrocarbyloxide, for example, methoxide, ethoxide, isopropoxide, phenoxide; carboxylate, for example, formate, acetate, benzoate; hydrocarbyl, for example, methyl, ethyl, propyl, butyl, octyl, decyl, phenyl, benzyl; substituted hydrocarbyl; heterohydrocarbyl; tosylate; and triflate. Preferably X is selected from halide, hydride and hydrocarbyl. Chloride is particularly preferred.

The group L may be an ether such as tetrahydrofuran or diethylether, and alcohol such as ethanol or butanol, a primary, secondary or tertiary amine, or a phosphine.

A second aspect of the invention provides a polymerisation catalyst comprising

(a) a complex as defined above, and

(b) an effective amount of at least one activator compound.

The activator compound for the catalyst of the present invention is suitably selected from organoaluminium compounds and hydrocarbylboron compounds. Suitable organoaluminium compounds include compounds of the formula AlR₃, where each R is independently C₁-C₁₂ alkyl or halo. Examples include trimethylaluminium (TMA), triethylaluminium (TEA), tri-isobutylaluminium (TIBA), tri-n-octylaluminium, methylaluminium dichloride, ethylaluminium dichloride, dimethylaluminium chloride, diethylaluminium chloride, ethylaluminiumsesquichloride, methylaluminiumsesquichloride, and alumoxanes. Alumoxanes are well known in the art as typically the oligomeric compounds which can be prepared by the controlled addition of water to an alkylaluminium compound, for example trimethylaluminium. Such compounds can be linear, cyclic or mixtures thereof. Commercially available alumoxanes are generally believed to be mixtures of linear and cyclic compounds. The cyclic alumoxanes can be represented by the formula [R¹⁶AlO], and the linear alumoxanes by the formula R¹⁷(R¹⁸AlO)ₛ wherein s is a number from about 2 to 50, and wherein R¹⁶, R¹⁷, and R¹⁸ represent hydrocarbyl groups, preferably C₁ to C₆ alkyl groups, for example methyl, ethyl or butyl groups. Alkylalumoxanes such as methylalumoxane (MAO) are preferred.

Mixtures of alkylalumoxanes and trialkylaluminium compounds are particularly preferred, such as MAO with TMA or TIBA. In this context it should be noted that the term “alkylalumoxane” as used in this specification includes alkylalumoxanes available commercially which may contain a proportion, typically about 10 wt %, but optionally up to 50 wt %, of the corresponding trialkylaluminium; for instance, commercial MAO usually contains approximately 10 wt % trimethylaluminium (TMA), whilst commercial MMAO contains both TMA and TIBA. Quantities of alkylalumoxane quoted herein include such trialkylaluminium impurities, and accordingly quantities of trialkylaluminium compounds quoted herein are considered to comprise compounds of the formula AlR₃ additional to any AlR₃ compound incorporated within the alkylalumoxane when present.

Examples of suitable hydrocarbylboron compounds are boroxines, trimethylboron, triethylboron, dimethylphenylammoniumtetra(phenyl)borate, trityltetra(phenyl)borate, triphenylboron, dimethylphenylammonium tetra(pentafluorophenyl)borate, sodium tetrakis[(bis-3,5-trifluoromethyl)phenyl]borate, H⁺(OEt₂)[(bis-3,5-trifluoromethyl)phenyl]borate, trityltetra(pentafluorophenyl)borate and tris(pentafluorophenyl) boron.

In the preparation of the catalysts of the present invention the quantity of activating compound selected from organoaluminium compounds and hydrocarbylboron compounds to be employed is easily determined by simple testing, for example, by the preparation of small test samples which can be used to polymerise small quantities of the monomer(s) and thus to determine the activity of the produced catalyst. It is generally found that the quantity employed is sufficient to provide 0.1 to 20,000 atoms, preferably 1 to 2000 atoms of aluminium or boron per atom of chromium in the compound of Formula (I).

An alternative class of activators comprise salts of a cationic oxidising agent and a non-coordinating compatible anion. Examples of cationic oxidising agents include: ferrocenium, hydrocarbyl-substituted ferrocenium, Ag⁺, or Pb²⁺. Examples of non-coordinating compatible anions are BF₄⁻, SbCl₆⁻, PF₆⁻, tetrakis(phenyl)borate and tetrakis(pentafluorophenyl)borate.

The polymerisation catalyst of the present invention may also comprise (3) a neutral Lewis base.

Neutral Lewis bases are well known in the art of Ziegler-Natta catalyst polymerisation technology. Examples of classes of neutral Lewis bases suitably employed in the present invention are unsaturated hydrocarbons, for example, alkenes (other than 1-olefins) or alkynes, primary, secondary and tertiary amines, amides, phosphoramides, phosphines, phosphites, ethers, thioethers, nitriles, carbonyl compounds, for example, esters, ketones, aldehydes, carbon monoxide and carbon dioxide, sulphoxides, sulphones and boroxines. Although 1-olefins are capable of acting as neutral Lewis bases, for the purposes of the present invention they are regarded as monomer or comonomer 1-olefins and not as neutral Lewis bases per se. However, alkenes which are internal olefins, for example, 2-butene and cyclohexene are regarded as neutral Lewis bases in the present invention. Preferred Lewis bases are tertiary amines and aromatic esters, for example, dimethylaniline, diethylaniline, tributylamine, ethylbenzoate and benzylbenzoate. In this particular aspect of the present invention, components (1), (2) and (3) of the catalyst system can be brought together simultaneously or in any desired order. However, if components (2) and (3) are compounds which interact together strongly, for example, form a stable compound together, it is preferred to bring together either components (1) and (2) or components (1) and (3) in an initial step before introducing the final defined component. Preferably components (1) and (3) are contacted together before component (2) is introduced. The quantities of components (1) and (2) employed in the preparation of this catalyst system are suitably as described above in relation to the catalysts of the present invention. The quantity of the neutral Lewis Base [component (3)] is preferably such as to provide a ratio of component (1):component (3) in the range 100:1 to 1:1000, most preferably in the range 1:1 to 1:20. Components (1), (2) and (3) of the catalyst system can brought together, for example, as the neat materials, as a suspension or solution of the materials in a suitable diluent or solvent (for example a liquid hydrocarbon), or, if at least one of the components is volatile, by utilising the vapour of that component. The components can be brought together at any desired temperature. Mixing the components together at room temperature is generally satisfactory. Heating to higher temperatures e.g. up to 120° C. can be carried out if desired, e.g. to achieve better mixing of the components. It is preferred to carry out the bringing together of components (1), (2) and (3) in an inert atmosphere (e.g. dry nitrogen) or in vacuo. If it is desired to use the catalyst on a support material (see below), this can be achieved, for example, by preforming the catalyst system comprising components (1), (2) and (3) and impregnating the support material preferably with a solution thereof, or by introducing to the support material one or more of the components simultaneously or sequentially. If desired the support material itself can have the properties of a neutral Lewis base and can be employed as, or in place of, component (3). An example of a support material having neutral Lewis base properties is poly(aminostyrene) or a copolymer of styrene and aminostyrene (ie vinylaniline).

The catalysts of the present invention can if desired comprise more than one of the defined compounds. Alternatively, the catalysts of the present invention can also include one or more other types of transition metal compounds or catalysts, for example, nitrogen containing catalysts such as those described in WO 99/12981. Examples of such other catalysts include 2,6-diacetylpyridinebis(2,4,6-trimethyl anil)FeCl₂.

The catalysts of the present invention can also include one or more other types of catalyst, such as those of the type used in conventional Ziegler-Natta catalyst systems, metallocene-based catalysts, monocyclopentadienyl- or constrained geometry based catalysts, or heat activated supported chromium oxide catalysts (eg Phillips-type catalyst).

The catalysts of the present invention can be unsupported or supported on a support material, for example, silica, alumina, MgCl₂ or zirconia, or on a polymer or prepolymer, for example polyethylene, polypropylene, polystyrene, or poly(aminostyrene).

If desired the catalysts can be formed in situ in the presence of the support material, or the support material can be pre-impregnated or premixed, simultaneously or sequentially, with one or more of the catalyst components. The catalysts of the present invention can if desired be supported on a heterogeneous catalyst, for example, a magnesium halide supported Ziegler Natta catalyst, a Phillips type (chromium oxide) supported catalyst or a supported metallocene catalyst. Formation of the supported catalyst can be achieved for example by treating the transition metal compounds of the present invention with alumoxane in a suitable inert diluent, for example a volatile hydrocarbon, slurrying a particulate support material with the product and evaporating the volatile diluent. The produced supported catalyst is preferably in the form of a free-flowing powder. The quantity of support material employed can vary widely, for example from 100,000 to 1 grams per gram of metal present in the transition metal compound.

Alternatively the precursor components of the catalyst may be added directly to the polymerisation reactor together with the 1-olefin to be polymerised.

The present invention further provides a process for the polymerisation and copolymerisation of 1-olefins, comprising contacting the monomeric olefin under polymerisation conditions with the polymerisation catalyst of the present invention. An alternative process comprises contacting the monomeric olefin under polymerisation conditions with

(a) a ligand as defined above,

(b) a source of a Group VI metal, and

(b) an effective amount of at least one activator compound.

A preferred process comprises the steps of:

(a) preparing a prepolymer-based catalyst by contacting one or more 1-olefins with a catalyst system, and

(b) contacting the prepolymer-based catalyst with one or more 1-olefins, wherein the catalyst system is as defined above.

In the text hereinbelow, the term “catalyst” is intended to include “prepolymer-based catalyst” as defined above.

The polymerisation conditions can be, for example, solution phase, slurry phase, gas phase or bulk phase, with polymerisation temperatures ranging from −100° C. to +300° C., and at pressures of atmospheric and above, particularly from 140 to 4100 kPa. If desired, the catalyst can be used to polymerise ethylene under high pressure/high temperature process conditions wherein the polymeric material forms as a melt in supercritical ethylene. Preferably the polymerisation is conducted under gas phase fluidised bed or stirred bed conditions.

Suitable monomers for use in the polymerisation process of the present invention are, for example, ethylene and C₂₋₂₀ α-olefins, specifically propylene, 1-butene, 1-pentene, 1-hexene, 4-methylpentene-1, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nonadecene, and 1-eicosene. Other monomers include methyl methacrylate, methyl acrylate, butyl acrylate, acrylonitrile, vinyl acetate, and styrene. Preferred monomers for homopolymerisation processes are ethylene and propylene.

The catalysts and process of the invention can also be used for copolymerising ethylene or propylene with each other or with other 1-olefins such as 1-butene, 1-hexene, 4-methylpentene-1, and octene, or with other monomeric materials, for example, methyl methacrylate, methyl acrylate, butyl acrylate, acrylonitrile, vinyl acetate, and styrene. Polymerisation of 1-olefins with dienes, particularly non-conjugated dienes, such as 1,4 pentadiene, 1,5-hexadiene, cyclopentadiene and ethylene norbornadiene is also possible. In particular, ethylene/1-olefin/diene terpolymers may be made by the process of the invention where the diene is as above and the other 1-olefin is preferably propylene. Copolymerisation may be conducted in which a comonomer is added to the reactor or produced in situ using another catalyst. When the catalyst of the present invention is used to make copolymer materials from two or more olefinic monomers, the final polymer can contain any weight percent of each monomer. For example, in a co-polymer of ethylene and a 1-olefin such as 1-butene or 1-hexene, the 1-olefin may constitute from 0.001 to 99.999 weight percent of the final polymer, preferably from 0.1 to 99.9 weight percent of the final polymer, more preferably from 0.5 to 50 weight percent of the final polymer and even more preferably from 1 to 25 weight percent of the final polymer.

Irrespective of the polymerisation or copolymerisation technique employed, polymerisation or copolymerisation is typically carried out under conditions that substantially exclude oxygen, water, and other materials that act as catalyst poisons. Also, polymerisation or copolymerisation can be carried out in the presence of additives to control polymer or copolymer molecular weights.

The use of hydrogen gas as a means of controlling the average molecular weight of the polymer or copolymer applies generally to the polymerisation process of the present invention. For example, hydrogen can be used to reduce the average molecular weight of polymers or copolymers prepared using gas phase, slurry phase, bulk phase or solution phase polymerisation conditions. The quantity of hydrogen gas to be employed to give the desired average molecular weight can be determined by simple “trial and error” polymerisation tests.

The polymerisation process of the present invention provides polymers and copolymers, especially ethylene polymers, at remarkably high productivity (based on the amount of polymer or copolymer produced per unit weight of complex employed in the catalyst system). This means that relatively very small quantities of transition metal complex are consumed in commercial processes using the process of the present invention. It also means that when the polymerisation process of the present invention is operated under polymer recovery conditions that do not employ a catalyst separation step, thus leaving the catalyst, or residues thereof, in the polymer (e.g. as occurs in most commercial slurry and gas phase polymerisation processes), the amount of transition metal complex in the produced polymer can be very small.

Slurry phase polymerisation conditions or gas phase polymerisation conditions are particularly useful for the production of high or low density grades of polyethylene, and polypropylene. In these processes the polymerisation conditions can be batch, continuous or semi-continuous. Furthermore, one or more reactors may be used, e.g. from two to five reactors in series. Different reaction conditions, such as different temperatures or hydrogen concentrations may be employed in the different reactors. In the slurry phase process and the gas phase process, the, catalyst is generally metered and transferred into the polymerisation zone in the form of a particulate solid either as a dry powder (e.g. with an inert gas) or as a slurry. This solid can be, for example, a solid catalyst system formed from the one or more of complexes of the invention and an activator with or without other types of catalysts, or can be the solid catalyst alone with or without other types of catalysts. In the latter situation, the activator can be fed to the polymerisation zone, for example as a solution, separately from or together with the solid catalyst. Preferably the catalyst system or the transition metal complex component of the catalyst system employed in the slurry polymerisation and gas phase polymerisation is supported on one or more support materials. Most preferably the catalyst system is supported on the support material prior to its introduction into the polymerisation zone. Suitable support materials are, for example, silica, alumina, zirconia, talc, kieselguhr, or magnesia. Impregnation of the support material can be carried out by conventional techniques, for example, by forming a solution or suspension of the catalyst components in a suitable diluent or solvent, and slurrying the support material therewith. The support material thus impregnated with catalyst can then be separated from the diluent for example, by filtration or evaporation techniques. Once the polymer product is discharged from the reactor, any associated and absorbed hydrocarbons are substantially removed, or degassed, from the polymer by, for example, pressure let-down or gas purging using fresh or recycled steam, nitrogen or light hydrocarbons (such as ethylene). Recovered gaseous or liquid hydrocarbons may be recycled to the polymerisation zone.

In the slurry phase polymerisation process the solid particles of catalyst, or supported catalyst, are fed to a polymerisation zone either as dry powder or as a slurry in the polymerisation diluent. The polymerisation diluent is compatible with the polymer(s) and catalyst(s), and may be an alkane such as hexane, heptane, isobutane, or a mixture of hydrocarbons or paraffins. Preferably the particles are fed to a polymerisation zone as a suspension in the polymerisation diluent. The polymerisation zone can be, for example, an autoclave or similar reaction vessel, or a continuous loop reactor, e.g. of the type well-know in the manufacture of polyethylene by the Phillips Process. When the polymerisation process of the present invention is carried out under slurry conditions the polymerisation is preferably carried out at a temperature above 0° C., most preferably above 15° C. The polymerisation temperature is preferably maintained below the temperature at which the polymer commences to soften or sinter in the presence of the polymerisation diluent. If the temperature is allowed to go above the latter temperature, fouling of the reactor can occur. Adjustment of the polymerisation within these defined temperature ranges can provide a useful means of controlling the average molecular weight of the produced polymer. A further useful means of controlling the molecular weight is to conduct the polymerisation in the presence of hydrogen gas which acts as chain transfer agent. Generally, the higher the concentration of hydrogen employed, the lower the average molecular weight of the produced polymer.

In bulk polymerisation processes, liquid monomer such as propylene is used as the polymerisation medium.

Methods for operating gas phase polymerisation processes are well known in the art. Such methods generally involve agitating (e.g. by stirring, vibrating or fluidising) a bed of catalyst, or a bed of the target polymer (i.e. polymer having the same or similar physical properties to that which it is desired to make in the polymerisation process) containing a catalyst, and feeding thereto a stream of monomer at least partially in the gaseous phase, under conditions such that at least part of the monomer polymerises in contact with the catalyst in the bed. The bed is generally cooled by the addition of cool gas (e.g. recycled gaseous monomer) and/or volatile liquid (e.g. a volatile inert hydrocarbon, or gaseous monomer which has been condensed to form a liquid). The polymer produced in, and isolated from, gas phase processes forms directly a solid in the polymerisation zone and is free from, or substantially free from liquid. As is well known to those skilled in the art, if any liquid is allowed to enter the polymerisation zone of a gas phase polymerisation process the quantity of liquid in the polymerisation zone is small in relation to the quantity of polymer present. This is in contrast to “solution phase” processes wherein the polymer is formed dissolved in a solvent, and “slurry phase” processes wherein the polymer forms as a suspension in a liquid diluent.

The gas phase process can be operated under batch, semi-batch, or so-called “continuous” conditions. It is preferred to operate under conditions such that monomer is continuously recycled to an agitated polymerisation zone containing polymerisation catalyst, make-up monomer being provided to replace polymerised monomer, and continuously or intermittently withdrawing produced polymer from the polymerisation zone at a rate comparable to the rate of formation of the polymer, fresh catalyst being added to the polymerisation zone to replace the catalyst withdrawn form the polymerisation zone with the produced polymer.

For typical production of impact copolymers, homopolymer formed from the first monomer in a first reactor is reacted with the second monomer in a second reactor. For manufacture of propylene/ethylene impact copolymer in a gas-phase process, propylene is polymerized in a first reactor; reactive polymer transferred to a second reactor in which ethylene or other comonomer is added. The result is an intimate mixture of a isotactic polypropylene chains with chains of a random propylene/ethylene copolymer. A random copolymer typically is produced in a single reactor in which a minor amount of a comonomer (typically ethylene) is added to polymerizing chains of propylene.

Methods for operating gas phase fluidised bed processes for making polyethylene, ethylene copolymers and polypropylene are well known in the art. The process can be operated, for example, in a vertical cylindrical reactor equipped with a perforated distribution plate to support the bed and to distribute the incoming fluidising gas stream through the bed. The fluidising gas circulating through the bed serves to remove the heat of polymerisation from the bed and to supply monomer for polymerisation in the bed. Thus the fluidising gas generally comprises the monomer(s) normally together with some inert gas (e.g. nitrogen or inert hydrocarbons such as methane, ethane, propane, butane, pentane or hexane) and optionally with hydrogen as molecular weight modifier. The hot fluidising gas emerging from the top of the bed is led optionally through a velocity reduction zone (this can be a cylindrical portion of the reactor having a wider diameter) and, if desired, a cyclone and or filters to disentrain fine solid particles from the gas stream. The hot gas is then led to a heat exchanger to remove at least part of the heat of polymerisation. Catalyst is preferably fed continuously or at regular intervals to the bed. At start up of the process, the bed comprises fluidisable polymer which is preferably similar to the target polymer. Polymer is produced continuously within the bed by the polymerisation of the monomer(s). Preferably means are provided to discharge polymer from the bed continuously or at regular intervals to maintain the fluidised bed at the desired height. The process is generally operated at relatively low pressure, for example, at 10 to 50 bars, and at temperatures for example, between 50 and 120° C. The temperature of the bed is maintained below the sintering temperature of the fluidised polymer to avoid problems of agglomeration.

In the gas phase fluidised bed process for polymerisation of olefins the heat evolved by the exothermic polymerisation reaction is normally removed from the polymerisation zone (i.e. the fluidised bed) by means of the fluidising gas stream as described above. The hot reactor gas emerging from the top of the bed is led through one or more heat exchangers wherein the gas is cooled. The cooled reactor gas, together with any make-up gas, is then recycled to the base of the bed. In the gas phase fluidised bed polymerisation process of the present invention it is desirable to provide additional cooling of the bed (and thereby improve the space time yield of the process) by feeding a volatile liquid to the bed under conditions such that the liquid evaporates in the bed thereby absorbing additional heat of polymerisation from the bed by the “latent heat of evaporation” effect. When the hot recycle gas from the bed enters the heat exchanger, the volatile liquid can condense out. In one embodiment of the present invention the volatile liquid is separated from the recycle gas and reintroduced separately into the bed. Thus, for example, the volatile liquid can be separated and sprayed into the bed. In another embodiment of the present invention the volatile liquid is recycled to the bed with the recycle gas. Thus the volatile liquid can be condensed from the fluidising gas stream emerging from the reactor and can be recycled to the bed with recycle gas, or can be separated from the recycle gas and then returned to the bed.

The method of condensing liquid in the recycle gas stream and returning the mixture of gas and entrained liquid to the bed is described in EP-A-0089691 and EP-A-0241947. It is preferred to reintroduce the condensed liquid into the bed separate from the recycle gas using the process described in our U.S. Pat. No. 5,541,270, the teaching of which is hereby incorporated into this specification.

When using the catalysts of the present invention under gas phase polymerisation conditions, the catalyst, or one or more of the components employed to form the catalyst can, for example, be introduced into the polymerisation reaction zone in liquid form, for example, as a solution in an inert liquid diluent. Thus, for example, the transition metal component, or the activator component, or both of these components can be dissolved or slurried in a liquid diluent and fed to the polymerisation zone. Under these circumstances it is preferred the liquid containing the component(s) is sprayed as fine droplets into the polymerisation zone. The droplet diameter is preferably within the range 1 to 1000 microns. EP-A-0593083, the teaching of which is hereby incorporated into this specification, discloses a process for introducing a polymerisation catalyst into a gas phase polymerisation. The methods disclosed in EP-A-0593083 can be suitably employed in the polymerisation process of the present invention if desired.

Although not usually required, upon completion of polymerisation or copolymerisation, or when it is desired to terminate polymerisation or copolymerisation or at least temporarily deactivate the catalyst or catalyst component of this invention, the catalyst can be contacted with water, alcohols, acetone, or other suitable catalyst deactivators a manner known to persons of skill in the art.

Homopolymerisation of ethylene with the catalysts of the invention may produce so-called “high density” grades of polyethylene. These polymers have relatively high stiffness and are useful for making articles where inherent rigidity is required. Copolymerisation of ethylene with higher 1-olefins (e.g. butene, hexene or octene) can provide a wide variety of copolymers differing in density and in other important physical properties. Particularly important copolymers made by copolymerising ethylene with higher 1-olefins with the catalysts of the invention are the copolymers having a density in the range of 0.91 to 0.93. These copolymers which are generally referred to in the art as linear low density polyethylene, are in many respects similar to the so called low density polyethylene produced by the high pressure free radical catalysed polymerisation of ethylene. Such polymers and copolymers are used extensively in the manufacture of flexible blown film.

Propylene polymers produced by the process of the invention include propylene homopolymer and copolymers of propylene with less than 50 mole % ethylene or other alpha-olefin such as butene-1, pentene-1, 4-methylpentene-1, or hexene-1, or mixtures thereof. Propylene polymers also may include copolymers of propylene with minor amounts of a copolymerizable monomer. Typically, most useful are normally-solid polymers of propylene containing polypropylene crystallinity, random copolymers of propylene with up to about 10 wt. % ethylene, and impact copolymers containing up to about 20 wt. % ethylene or other alpha-olefin. Polypropylene homopolymers may contain a small amount (typically below 2 wt. %) of other monomers to the extent the properties of the homopolymer are not affected significantly.

Propylene polymers may be produced which are normally solid, predominantly isotactic, poly α-olefins. Levels of stereorandom by-products are sufficiently low so that useful products can be obtained without separation thereof. Typically, useful propylene homopolymers show polypropylene crystallinity and have isotactic indices above 90 and many times above 95. Copolymers typically will have lower isotactic indices, typically above 80-85.

Depending upon polymerisation conditions known in the art, propylene polymers with melt flow rates from below 1 to above 1000 may be produced in a reactor. For many applications, polypropylenes with a MFR from 2 to 100 are typical. Some uses such as for spunbonding may use a polymer with an MFR of 500 to 2000.

Depending upon the use of the polymer product, minor amounts of additives are typically incorporated into the polymer formulation such as acid scavengers, antioxidants, stabilizers, and the like. Generally, these additives are incorporated at levels of about 25 to 2000 ppm, typically from about 50 to about 1000 ppm, and more typically 400 to 1000 ppm, based on the polymer.

In use, polymers or copolymers made according to the invention in the form of a powder are conventionally compounded into pellets. Examples of uses for polymer compositions made according to the invention include use to form fibres, extruded films, tapes, spunbonded webs, moulded or thermoformed products, and the like. The polymers may be blown into films, or may be used for making a variety of moulded or extruded articles such as pipes, and containers such as bottles or drums. Specific additive packages for each application may be selected as known in the art. Examples of supplemental additives include slip agents, anti-blocks, anti-stats, mould release agents, primary and secondary anti-oxidants, clarifiers, nucleants, uv stabilizers, and the like. Classes of additives are well known in the art and include phosphite antioxidants, hydroxylamine (such as N,N-dialkyl hydroxylamine) and amine oxide (such as dialkyl methyl amine oxide) antioxidants, hindered amine light (uv) stabilizers, phenolic stabilizers, benzofuranone stabilizers, and the like. Various olefin polymer additives are described in U.S. Pat. Nos. 4,318,845, 4,325,863, 4,590,231, 4,668,721, 4,876,300, 5,175,312, 5,276,076, 5,326,802, 5,344,860, 5,596,033, and 5,625,090.

Fillers such as silica, glass fibers, talc, and the like, nucleating agents, and colourants also may be added to the polymer compositions as known by the art.

### EXAMPLES

### Example 1

### Synthesis of N-isopropyl 3-(9-anthracenyl)-2-hydroxybenzyaldimine [N-isopropyl anthracenyl-salicylaldimine]

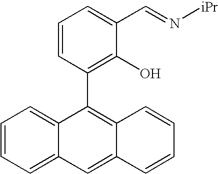

To a slurry of anthracenyl salicylaldehyde (0.50 g, 1.676 mmol) suspended in 10 ml of ethanol was added isopropylamine (0.30 ml, excess). The slurry was stirred overnight. The pale yellow product collected by filtration and washed with ethanol before being dried in a vacuum oven at 60° C. Yield 0.36 g (63%). ¹H-NMR □ 14.017(s, 1H, OH), 8.527(s, 1H, H5), 8.515(s, 1H, CHN), 8.065(brd, 2H J=7.7 Hz,), 7.699(brd, 2H J=7.7 Hz,), 7.52-7.34(brm, 6H, H2&3 and Hb&c), 7.105(t, 1H J=7.5 Hz, Hc), 3.583(sept, 1H J=6.4 Hz, ⁱPr—CH), 1.245(d, 6H J=6.4 Hz, ⁱPr—Me) ¹³C-NMR □ 162.06, 159.83, 135.27, 132.81, 131.56, 131.11, 130.42, 128.53, 126.84, 126.61, 126.16(?), 125.43, 125.02, 118.98, 118.21, 59.84, 24.13.

### Example 2

### Synthesis of p-Tolylchromiumdichloride tristetrahydrofuran [p-tolylCrCl₂.3THF]

To a solution of CrCl₂.3THF (1.20 g, 3.30 mmoles) dissolved in 40 ml of THF was added tolylMgBr (3.47 ml, 1M, 3.47 mmoles). The solution went green yelow and was allowed to react overnight. The solvent was removed under vacuum and the solids dissolved in a minimum toluene, filtered and dried under vacuum. The residue was dissolved in a minimum of THF and cooled overnight in a freezer to give a crop of green crystals which were recovered by filtration and washed with a small amount of cold ether. Yield 0.40 g (33%).

### Example 3

### Polymerisation Tests

Test A:

A mixture of N-isopropyl 3-(9-anthracenyl)-2-hydroxybenzyaldimine (10.2 mg, 0.030 mmol) and p-tolylCrCl₂.3THF (12.9 mg, 0.030 mmol) were dissolved in 10 ml of dry degassed toluene and allowed to stir for 5 minutes, the initial yellow colour turned a brown yellow. The solvent was removed under vacuum and the brown residue dissolved in 26 ml of dry degassed toluene. The pro-catalyst was activated by the addition of MAO (3.8 ml, 1.6 M, 6.0 mmol) and the slightly darker solution allowed to stir for 5 minutes. A 5 ml aliquot was transferred to a reaction vessel containing 100 ml of dry degassed toluene. The vessel was sealed and evacuated. The vessel was placed under 1 Bar of ethylene pressure and allowed to react for 15 minutes. The solution was deactivated by depressurising and addition of 100 ml of methanol containing 2 ml of dilute HCL. The polymer was recovered by filtration, washed with methanol and dried in a vacuum oven at 60° C. overnight.

Isolated polymer yield=1.08 g (equivalent to 860 g/mmol[Cr].h.b) GPC data: Mn=68000, Mw=143000, Mw/Mn=2.1

Test B:

A mixture of N-isopropyl 3-(9-anthracenyl)-2-hydroxybenzyaldimine (10.2 mg, 0.030 mmoles) and p-tolylCrCl₂.3THF (12.9 mg, 0.030 mmoles) were dissolved in 10 ml of dry degassed toluene and allowed to stir for 5 minutes, the initial yellow colour turned a brown yellow. The solvent was removed under vacuum and the brown residue dissolved in 26 ml of dry degassed toluene. The pro-catalyst was activated by the addition of MAO (3.8 ml, 1.6 M, 6.0 mmoles) and the slightly darker solution allowed to stir for 5 minutes. A 2 ml aliquot was transferred to a reaction vessel containing 100 mls of dry degassed toluene. The vessel was sealed and evacuated. The vessel was placed under 1 bar of ethylene pressure and allowed to react for 15 minutes. The solution was deactivated by depressurising and addition of 100 ml of methanol containing 2 ml of dilute HCl. The polymer was recovered by filtration, washed with methanol and dried in a vacuum oven at 60° C. overnight.

Isolated polymer yield=0.88 g (equivalent to 1760 g/mmol[Cr].h.b)

### Example 4

PhO.MOM (MOM=CH₃OCH₂—),¹ phenyl-salacylaldehyde² and 2-carboxybenzenediazonium betaine³ were made by literature methods.

¹H NMR have been numbered following the system shown above. ¹Yardley, J. P.; Fletcher 3rd, H. Synthesis 1976, 244 ²Matsui, S.; Tohi, Y.; Mitani, M.; Saito, J.; Makio, H.; Tanaka, H.; Nitabaru, M.; Nakano, T.; Fujita, T. Chem. Lett. 1999, 1065-1066 ³Atanes, N.; Castedo, L.; Cobas, A.; Guitián, E.; Saá, C. and Saá, J. M. Tetrahedron 1989, 45(24), 7947-7956. ⁴Daly, J. J.; Seeden, R. P. A. Journal of the Chemical Society A 1967, 89, 736

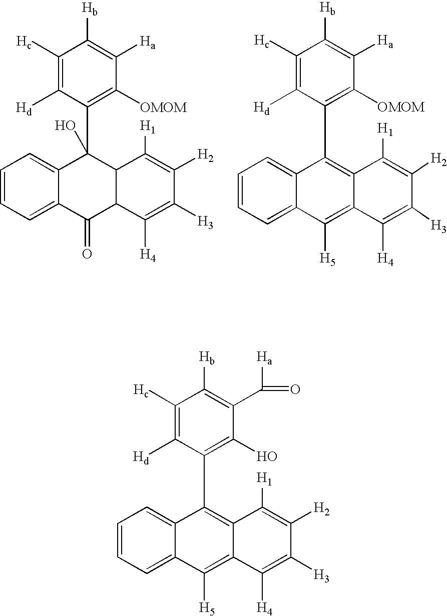

10-hydroxy-10-(2-(methoxymethoxy)-phenyl)-anthrone (1)

To a solution of PhOMOM (16 g, 0.116 moles) in 200 ml of ether cooled in water bath was added BuLi (60 ml, 2.5 M, 0.15 moles) and the solution stirred overnight. A precipitate of ortho-lithiated PhOMOM started to form after 5-15 minutes. The resulting slurry was added slowly (dropwise) to a slurry of anthraquinone (45 g, excess) in 500 ml of THF at RT, the solution going a deep green. After addition the solution was stirred for 1 hour then dilute HCl added to acidify the mix. The slurry was filtered into a separating flask and the organic phase washed with 2×200 ml of distilled water. The solvent was removed by rotary evaporation and the recovered solids slurried in 400 ml of THF (≈10 ml/g of product). The excess anthraquinone was removed by filtration and the solids washed with 50 ml of THF. The solvent was removed on a rotary evaporator and the solids slurried in a minimum of MeOH and filtered to remove most of the coloured material. The dried solids were recrystallised from hot toluene. A second crop of crystals were recovered from the filtrates by removing the solvent, extracting with THF, filtering, drying and recrystallisation from hot toluene. Clear colourless crystals were obtained, at a yield of 90.5%. The same procedure was followed reacting the lithium salt with MgBr₂ to form the Grignard reagent. ¹H NMR (400 MHz, CDCl₃) δ 2.565 (s, 3H, —OMe), 2.802 (s, 1H, —OH), 4.470 (s, 2H, —OCH₂), 6.785 (dd, 1H, J=7.8 & 1.1, Hₐ), 7.168 (dt, 1H, J=7.6 & 1.1, H_{c}), 7.246 (dt, 1H, J=7.8 & 1.7, H_{b}), 7.398 (dt, 2H, J=7.4 & 1.4, H₃), 7.440 (dd, 2H, J=7.3 & 1.2, H₁), 7.502 (dt, 2H, J=7.5 & 1.4, H₂), 8.252 (dd, 2H, J=7.6 & 1.1, H₄), 8.322 (dd, 1H, J=7.7& 1.7, H_{d}). ¹³C{¹H} NMR (100 MHz, CDCl₃) δ 184.24, 151.93, 146.85, 133.84, 133.48, 130.49, 129.11, 127.94, 127.80, 126.24, 125.73, 121.73, 113.51, 92.50, 70.84, 55.00.

9-(2-methoxymethoxy-phenyl)-anthracene (2)

To a suspension of 1 (20 g, 57.7 mmoles) in 900 mls of 50/50 H₂O/HOAc was added ZnCl₂ (3.9 g, 28.9 mmoles) then Zn (20 g, excess) and the suspension heated to 60° C. overnight (with effective stirring the reaction finished after ≈4 hours). The suspension was cooled and diluted with 2 litres of distilled water, stirred for 30 minutes and then allowed to settle. The majority of the water was decanted, 200 mls of toluene added to dissolve the product and the solution filtered to remove unreacted Zn, the aqueous phase separated and the organic phase washed with 2×200 ml of distilled water. The toluene was removed on a rotary evaporator. The solids were slurried in a minimum of methanol, filtered and dried. The impure material was recrystallised from a minimum of hot MeOH/toluene 80/20 to yield a pale yellow crystalline solid. Yield was 90.2% ¹H NMR (400 MHz, CDCl₃) δ 3.05 (s, 3H, —OMe), 4.919 (s, 2H, —OCH₂), 7.252 (dt, 1H, J=7.4 & 1.0, H_{c}), 7.329 (dd, 1H, J=7.5 & 1.8, H_{d}), 7.370 (dt, 2H, J=8.8 & 1.0, H₃), 7.399 (d, 1H, J=7.9, Hₐ), 7.472 (dt, 2H, J=8.7 & 1.0, H₂), 7.543 (dt, 1H, J=7.9 & 1.8, H_{b}), 7.684 (d, 2H, J=8.8, H₄), 8.062 (d, 2H, J=8.6, H₁), 8.511 (s, 1H, H₅). {Lit.^{5 1}H NMR δ 3.05(s, 3H), 4.92(s, 2H), 7.20-7.54(m, 8H), 7.66(d, 2H J=8.6 Hz), 8.06(d, 2H J=8.4 Hz), 8.51(s, 1H).} ¹³C{¹H} NMR (100 MHz, CDCl₃) δ 155.42, 133.67, 132.88, 131.36, 130.33, 129.27, 128.34, 126.73, 126.50, 125.19, 125.00, 121.97, 115.20, 94.12, 55.76. ⁵Rice, J. E. and Cai, Z-W. J. Org. Chem. 1993, 58, 1415-1424.

9-(2-methoxymethoxyphenyl)-triptycene (3)

To a solution of 2 (5 g, 31.8 mmoles) in 50 ml of refluxing DME was slowly added small portions of diazobenzenecarboxylate (formed from anthranilic acid, 4.35 g, 100% excess) slurried in DME. Gas evolution was allowed to cease before the next addition. The solution was cooled and the crude product precipitated by addition of 100 mls of distilled water. The solids were collected by filtration, slurried in ≈50 ml of MeOH and allowed to mix overnight, then filtered and washed with 2×20 ml of MeOH to removed coloured material. Yield was 77%. ¹H NMR (400 MHz, CDCl₃) δ 3.081 (s, 3H, —OMe), 4.794 (s, 2H, —OCH₂), 5.388 (s, 1H, CH), 6.911 (dt, 3H, J=7.5 & 1.3, H₂), 6.972 (dt, 3H, J=7.3 & 1.1, H₃), 7.219 (d, 3H, J=7.5, H₁), 7.320 (dt, 1H, J=7.5 & 1.5, H_{c}), 7.409 (dd, 3H, J=7.3 & 1.1, H₄), 7.495 (dd, 1H, J=8.3 & 1.4, Hₐ), 7.550 (dt, 1H, J=7.5 & 1.4, H_{b}), 8.454 (dd, 1H, J=7.9 &1.5,H_{d}). ¹³C{¹H} NMR (100 MHz, CDCl₃) δ 157.58, 146.12(2 coincident peaks), 131.75, 129.27, 125.58, 124.82, 124.66, 124.18, 123.29, 121.45, 115.42, 94.34, 59.29, 56.01, 55.16.

2-hydroxy-3-(9-triptycyl)-benzaldehyde [3-(9-triptycyl)-salicylaldehyde] (4)

To a slurry of 3 in DME (20 ml) was added BuLi and the slurry stirred overnight. The slurry was cooled to −78° C. in a dry ice/acetone bath, and DMF (5 ml, excess) added. The mixture was allowed to warm to room temperature and then stirred for 1 hour. The reaction mixture was deactivated by addition of dilute HCl followed by 100 ml of distilled water. The precipitated product was collected by filtration and washed with water. The crude product was dissolved in 50 ml of THF and 50 mls of 5 M HCl added. The slurry was refluxed for 3 hours, cooled and diluted with 100 ml of distilled water. The crude product was collected by filtration, washed with water, slurried with a minimum amount of methanol, filtered and washed with a small portion of cold methanol then dried under vacuum. The yellow solid was >95% pure and was used without further purification. ¹H NMR (400 MHz, CDCl₃) δ 5.447 (s, 1H, CH), 6.961 (dt, 3H, J=7.5 & 1.3, H₂), 7.029 (dt, 3H, J=7.2 & 1.0, H₃), 7.217 (d, 3H, J=7.5, H₁), 7.367 (t, 1H, J=7.7, H_{c}), 7.460 (d, 3H, J=7.2 & 1.0, H₄), 7.822 (dd, 1H, J=7.6 & 1.5, H_{b}), 8.750 (dd, 1H, J=7.8 & 1.3, H_{d}), 10.084 (s, 1H, —CHO), 11.782 (s, 1H, —OH). ¹³C{¹H} NMR (100 MHz, CDCl₃) δ 196.94, 161.83, 146.15, 145.03, 139.55, 134.15, 125.55, 125.12, 124.56, 124.44, 123.63, 121.57, 119.51, 58.82, 55.19.

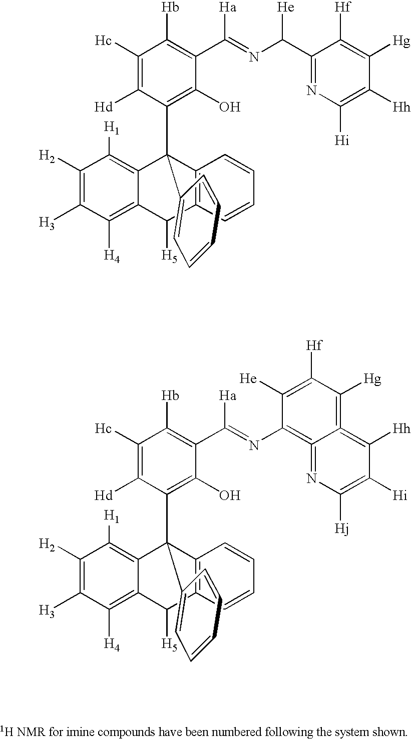

N-(2-pyridyl)-methyl 3-(9-triptycyl)-2-hydroxybenzyl imine (5) [N-(2-pyridyl)-methy triptycyl-salicylaldimine]

To a slurry of triptycyl-salicylaldehyde 4 (0.50 g, 1.33 mmoles) suspended in 10 mls of ethanol was added 2-aminomethylpyridine (0.50 ml, excess) and a drop of formic acid. The slurry was stirred at reflux overnight then cooled to room temperature of. The orange/red product collected by filtration and washed with ethanol before being dried in a vacuum oven at 60° C. Yield was 0.48 g 79.7(%). ¹H-NMR (400 MHz, CDCl₃) δ 4.940(s, 2H, Hₑ), 5.399(s, 1H, H₅), 6.917(dt, 3H J=7.7 & 1.3 Hz, H₂), 6.976(dt, 3H, J=7.3 & 1.0 Hz, H₃), 7.167(dd, 1H J=7.4 & 1.3 Hz, H_{b}), 7.223(t, 1H J=7.7 Hz, H_{c}), 7.255-7.294(m, 4H, H₁ & H_{f}), 7.412(dd, 3H J=7.2 & 1.1 Hz, H₄), 7.564(dd, 1H J=7.5 & 1.4 Hz, H_{b}), 7.606(dt, 1H J=7.7 & 1.8 Hz, H_{g}), 8.511 (dd, 1H J=7.9 & 1.4 Hz, H_{d}), 8.552(brd, 1H J=4.5 Hz, Hᵢ), 8.722(s, 1H, Hₐ), 13.989(s, 1H, OH). ¹³C{¹H} NMR (100 MHz, CDCl₃) δ 55.2, 59.1, 65.0, 118.1, 119.8, 122.3, 122.4, 123.4, 124.3, 124.5, 124.8, 125.0, 131.9, 135.2, 136.9, 145.5, 146.2, 149.3, 157.6, 161.3, 166.9.

N-8-Quinolinyl 3-(9-triptycyl)-2-hydroxybenzyl imine (6) [N-8-quinoliny triptycyl-salicylaldimine]

To a slurry of triptycyl-salicylaldehyde 4 (0.50 g, 1.33 mmoles) suspended in 10 mls of ethanol was added 8-aminoquinoline (0.30 g, excess) and a drop of formic acid. The slurry was stirred at reflux overnight then cooled to room temperature. The orange/red product collected by filtration and washed with ethanol before being dried in a vacuum oven at 60° C. Yield was 0.55 g 84.7(%). ¹H-NMR (250 MHz, CDCl₃) δ 5.415(s, 1H, H₅), 6.91-7.02(m, 6H, H₂ & H₃), 7.267(t, 1H J=7.7 Hz, H_{c}), 7.34-7.50(m, 9H), 7.548(t, 1H J=7.6 Hz), 8.556(dd, 1H J=7.9 & 1.6 Hz), 8.178(dd, 1H J=8.3 & 1.7 Hz), 8.556(dd, 2H H=7.9 & 1.4 Hz, H_{d}), 8.915(dd, 1H J=4.2 & 1.8 Hz), 9.305(s, 1H, Hₐ), 14.335(s, 1H, OH).

### Example 5

### Polymerisation

Polymerisation catalysis data is presented in Table 1 below.

Activated Catalyst Solution Formation

A mixture of the required ligand (0.030 mmoles) and p-tolylCrCl₂.3THF (12.9 mg, 0.030 mmoles) were dissolved in 10 ml of dry degassed toluene and allowed to stir for 5 minutes, the initial yellow colour turning a brown yellow. The solvent was removed under vacuum and the brown residue dissolved in 26.2 ml of dry degassed toluene. The pro-catalyst was activated by the addition of MAO (3.8 ml, 1.6 M, 6.0 mmoles) and the slightly darker solution allowed to stir for 5 minutes.

### Examples 5A, 5B and 5C

A 5 ml aliquot (5 μmoles) of the activated catalyst solution was transferred to a Schlenk containing 95 ml of dry degassed toluene. In the case of example 5A, hexane was added via syringe at this point. The vessel was sealed and evacuated. The vessel was placed under 1 bar of ethylene pressure and allowed to react for 1 hour. The solution was deactivated by depressurising and addition of 100 ml of methanol containing 2 ml of dilute HCl. The polymer was recovered by filtration, washed with methanol and dried in a vacuum oven at 60° C. overnight.

### Examples 5B and 5D

A 1 litre Buchi reactor was prepared with 400 ml of isobutane at the required temperature and pressure of ethylene. The reactor was scavenged with 1.25 ml of 1.6 M MAO (2.0 mmoles) solution in toluene. A 5 ml aliquot (5 μmoles) of the activated catalyst solution was transferred to the reactor and the ethylene uptake monitored for the catalyst run. After 60 minutes the isobutane was vented and the polymer collected and dried in a vacuum oven at 60° C. overnight.

TABLE 1
Polymerisation catalysis for Examples 5A-5E

| | Example | | | | |
|---|---|---|---|---|---|
| | 5A | 5B | 5C | 5D | 5E |
| Ligand | 5 | 5 | 6 | 6 | 6 |
| Cr:Al | 1:200 | 1:600 | 1:200 | 1:600 | 1:200 |
| Hexene (ml) | 0 | 0 | 0 | 0 | 2 |
| Temperature (° C.) | 25 | 50 | 25 | 50 | 25 |
| Pressure (Bar) | 1 | 4 | 1 | 4 | 1 |
| Yield (g) | 7.87 | 68.14 | 9.29 | 35.89 | 4.73 |
| Activity (g/mmol/ | 1574 | 3407 | 1858 | 1793 | 946 |
| bar/h) | | | | | |
| Mₙ | 1100 | 600 | 1000 | 600 | 1000 |
| M_{w} | 1900 | 1200 | 1700 | 1200 | 1650 |
| M_{w}/Mₙ | 1.8 | 2.0 | 1.7 | 2.0 | 1.6 |
| Mₚₖ | 1100 | 800 | 1100 | 700 | 1000 |
| Butyls (/1000Cs) | | | | | 2.7 |

Standard conditions were used:

Examples A, C, E: 5 μmoles Cr, 1 bar ethylene, 100 mls of toluene for 60 mins.

Examples B, D: 5 μmoles Cr, 50° C., 400 mls isobutane, 4 bar with 2.0 mmoles of MAO as a scavenger, 60 minutes.

### Example 6

### Synthesis of Salicylaldehydes 6A, 6E & 7C

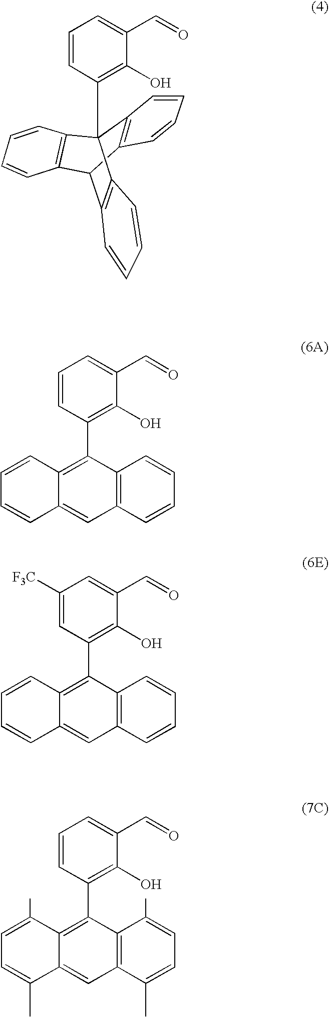

3-(9-anthracenyl)-2-hydroxy-benzaldehyde [3-(9-anthracenyl)-salicylaldehyde] (6A).

To a slurry of 2 (5.57 g, 17.72 mmoles) in DME (20 mls) was added BuLi (9.2 mls, 2.5 M, 23 mmoles) and the slurry stirred for 4 hours. The slurry was cooled to −78° C., dry ice/acetone bath, and DMF (5 ml, excess) added. The mixture was allowed to warm to RT and then stirred for 1 hour. The reaction mixture was deactivated by addition of dilute HCl then 100 mls of distilled water. The precipitated product was collected by filtration and washed with water. The crude product was dissolved in 50 mls of THF and 50 mls of 5 M HCl added. The slurry was refluxed for 3 hours, cooled and diluted with 100 mls of distilled water. The crude product was collected by filtration, washed with water, slurried with a minimum amount of methanol, filtered and washed with a small portion of cold methanol then dried under vacuum. The yellow solid was >99% pure and was used without further purification. Yield 89.9%. Recrystallisation from hot toluene gave analytically pure material. ¹H NMR (250 MHz, CDCl₃) δ 7.27 (t, 1H, J=7.51 Hz, Ph-H), 7.35-7.51 (m, 4H, Anth-H), 7.55-7.65 (m, 3H, Anth-H & Ph-H), 8.80 (dd, 1H, J=7.7 & 1.7 Hz, Ph-H), 8.08 (d, 2H, J=8.4 Hz, Anth-H), 8.56 (s, 1H, Anth-H)10.08 (s, 1H, CHO), 11.18 (s, 1H, OH).

4-trifluoromethylphenyl methoxymethyl ether (6B).

The MOM ether was made by modification to a literature method.⁶ To a solution of CF₃PhOH (5 g, 30.84 mmoles) in 100 mls of THF was added Na (1 g, excess) in small portions then stirred for 1 hour to form a solution of CF₃PhONa. This solution was slowly added to ClCH₂OMe [formed by slow addition of AcCl (2.7 mls, 37 mmoles) to (MeO)₂CH₂ (5 mls, excess), containing 0.1 g of ZnCl₂, cooled in a water bath]. The resultant mixture was stirred for 1 hour then deactivated by addition of 100 mls of distilled water. Ether (100 mls) was added and the mixture transferred to a separating funnel, the aqueous layer removed and the organic layer washed with 3×50 mls of 2 N NaOH, then with 2×50 mls of water. The organic phase was dried over MgSO₄, filtered and the solvent removed on a Rotovap. The crude product could be used without further purification. Yield 91 %. ¹H NMR (250 MHz, CDCl₃) δ 3.475(s 3H, —OMe), 5.232(s 2H, —OCH₂O), 7.113(d 2H, J=8.3 Hz, Ph-H), 7.551(d 2H, J=8.3 Hz, Ph-H). ⁶Minsky, A.; Rabinovitz, M. J. Am. Chem. Soc. 1984, 106, 6755-6759.

10-hydroxy-10-(2-methoxymethoxy)-5-trifluoromethylphenyl)-anthrone (6C).

Synthesised from CF₃PhOMOM (6B) and anthraquinone as for 1. ¹H NMR (400 MHz, CDCl₃) δ 2.493 (s, 3H, —OMe), 3.155 (s, 1H, —OH), 4.511 (s, 2H, —OCH₂—), 6.834 (d, 1H, J=8.6 Hz, Ph-H), 7.34-7.44 (m, 4H, Anth-H & Ph-H), 7.48-7.54 (m, 3H, Anth-H & Ph-H), 8.17 (d, 2H, J=7.1 Hz, Anth-H), 8.673 (d, 1H, J=2.0 Hz, Ph-H). ¹³C{¹H} NMR (100 MHz, CDCl₃) δ 184.1, 154.20, 145.96, 134.65, 133.61, 130.54, 128.59, 128.08, 127.92, 126.50(bq), 126.29, 124.68(q, J=243 Hz, —CF₃), 123.2(bq), 122.82, 113.42, 92.51, 55.17. ¹⁹F{¹H} (235.3 MHz, CDCl₃) δ -65.53(s).

9-(2-methoxymethoxy-5-trifluoromethylphenyl)-anthracene (6D).

Synthesised from 6C as for 2.

¹H NMR (250 MHz, CDCl₃) δ 3.10 (s, 3H, OMe), 4.98 (s, 2H, OCH₂), 7.33-7.6 (bm, 8H, Anth-H & Ph-H), 7.79 (m, 1H, Ph-H), 8.07 (d, 2H, J=8.5 Hz, Anth-H), 8.54 (s, 1H, Anth-H). ¹⁹F{¹H} (235.3 MHz, CDCl₃) δ -65.68(s).

3-(9-anthracenyl)-2-hydroxy-5-trifluoromethylbenzaldehyde [3-(9-anthracenyl)-5-trifluoromethylsalicylaldehyde] (6E).

Synthesised form 6D as for 6A. Yield 86%. ¹H NMR (250 MHz, CDCl₃) δ 7.38-7.55 (m, 6H, Anth-H), 7.87 (d, 1H, J=2.30 Hz, Ph-H), 7.05-8.15 (m, 3H, Anth-H & Ph-H), 8.59 (s, 1H, H5), 10.12 (s, 1H, CHO), 11.46 (s, 1H, OH) ¹⁹F {¹H} (235.3 MHz, CDCl₃) δ -65.98(s).

9-(2-methoxymethoxyphenyl)-triptycene (6F).

To a solution of 2 (5 g, 31.8 mmoles) in 50 mls of refluxing DME was slowly added small portions of diazocarboxylate (formed from anthranilic acid, 4.35 g, 100% excess) slurried in DME. Gas evolution was allowed to cease before the next addition. The solution was cooled and the crude product precipitated by addition of 100 mls of distilled water. The solids were collected by filtration, slurried in ≈50 mls of MeOH and allowed to mix overnight, filtered and washed with 2×20 mls of MeOH to removed coloured material. Yield 77% ¹H NMR (400 MHz, CDCl₃) δ 3.081 (s, 3H, —OMe), 4.794 (s, 2H, —OCH₂), 5.388 (s, 1H, CH), 6.911 (dt, 3H, J=7.5 & 1.3 Hz, Tript-H), 6.972 (dt, 3H, J=7.3 & 1.1 Hz, Tript-H), 7.219 (d, 3H, J=7.5 Hz, Tript-H), 7.320 (dt, 1H, J=7.5 & 1.5 Hz, Ph-H), 7.409 (dd,3H, J=7.3 & 1.1 Hz, Tript-H), 7.495 (dd, 1H, J=8.3 & 1.4 Hz, Ph-H), 7.550 (dt, 1H, J=7.5 & 1.4 Hz, Ph-H), 8.454 (dd, 1H, J=7.9 & 1.5 Hz, Ph-H). ¹³C{¹H} NMR (100 MHz, CDCl₃) δ 157.58, 146.12(2 coincident peaks), 131.75, 129.27, 125.58, 124.82, 124.66, 124.18, 123.29, 121.45, 115.42, 94.34, 59.29, 56.01, 55.16.

10-hydroxy-10-(2-methoxymethoxy-phenyl)-1,4,5,8-tetramethylanthrone (7A).

As for 1 using 1,4,5,8-tetramethylanthraquinone. Yield 85%. ¹H NMR (400 MHz, CDCl₃) δ 2.296 (s 1H, —OH), 2.377 (s 6H, —Me), 2.630 (s 3H, —OMe), 2.645 (s, 6H, Me), 4.684 (s, 2H, OCH₂), 6.812 (d 1H, J=8.1 Hz, Ph-H), 7.03-7.05(m, 5H, Anth-H & Ph-H), 7.169(dt 1H, J=8.1 & 1.7 Hz, Ph-H), 8.326 (dd 1H, J=7.9 & 1.7 Hz, Ph-H). ¹³C{¹H} NMR (100 MHz, CDCl₃) δ 192.02, 152.11, 143.71, 135.81, 135.19, 134.99, 132.78, 130.86, 130.46, 128.45, 127.73, 118.75, 113.07, 91.45, 54.89, 22.08, 21.96.

9-(2-methoxymethoxy-phenyl)-1,4,5,8-tetramethyanthracene (7B).

To a slurry of 7A (3 g, 7.45 mmoles) in 20 mls of ether was added LiAlH₄ (0.60 g, 14.91 mmoles) then BF₃.QEt₂ (0.125 mls, 0.15 g, 1.1 mmoles) and the reaction mix refluxed overnight. The slurry was deactivation by slow addition of dilute HCl. The organic phase was washed with 2×20 mls distilled water, dried over MgSO₄, filtered and the solvent removed under vacuum. The crude material was recrystallised from MeOH/toluene 80/20. Yield 88.4% ¹H NMR (250 MHz, CDCl₃) δ 1.95 (s, 6H, Me), 2.85 (s, 6H, Me), 4.71 (s, 1H, OH), 6.90-7.26 (m, 7H, Ph-H & Anth-H), 7.42, (dt, 1H, J=7.7 & 1.9 Hz, Ph-H), 8.85 (s, 1H, Anth-H)

2-hydroxy-3-(9-(1,4,5,8-tetramethylanthracenyl))-benzaldehyde [3-(9-(1,4,5,8-tetramethylanthracenyl))-salicylaldehyde] (7C).⁷ ⁷Wang, R. X.; You, X. Z.; Meng, Q. J.; Mintz, E. A.; Bu, X. R. Synth. Commun. 1994, 24, 1757-1760

To a solution of 7B (2.32 g, 6.53 mmoles) in 20 mls of toluene was added EtMgBr (2.37 mls, 3M, 6.53 mmoles) in THF followed by paraformaldehyde (0.53 g, 16.3 mmoles) and Et3N (1.5 mls, 1.08 g, 9.8 mmoles). The resulting solution was heated to 80° C. for 4 hours then deactivated with dilute HCl. The organic phase was separated, washed with dilute acid then water, 2×20 mls, then dried over Na₂SO₄. The solution ws recovered by filtration and the solvent removed ona Rotavap. The crude product was recrystalised from MeOH. Yield 72%. ¹H NMR (250 MHz, CDCl₃) δ 1.93 (s, 6H, Me), 2.83 (s, 6H, Me), 7.00-7.20 (m, 5H, Anth-H & Ph-H), 7.36 (dd, 1H, J=7.5 & 1.7 Hz, Ph-H), 7.74 (dd, 1H, J=7.7 & 1.8 Hz, Ph-H), 8.8 (s, 1H, H5), 10.04 (s, 1H, CHO), 11.37 (s, 1H, OH).

### Example 7—General Procedure for Synthesis of Ligands 9-40

All ligands were synthesized on a 0.4 mmol scale by condensation of the appropriate aldehyde (compounds 3 or 4 from Example 4 or compounds 7 and 8 from Example 6) with a commercially available primary amine in a mixture of 2:1 ethanol:toluene with a catalytic amount of acetic acid at 60° C. Products were isolated by precipitation and were >90% pure by LCMS or ¹H NMR analysis, as appropriate.

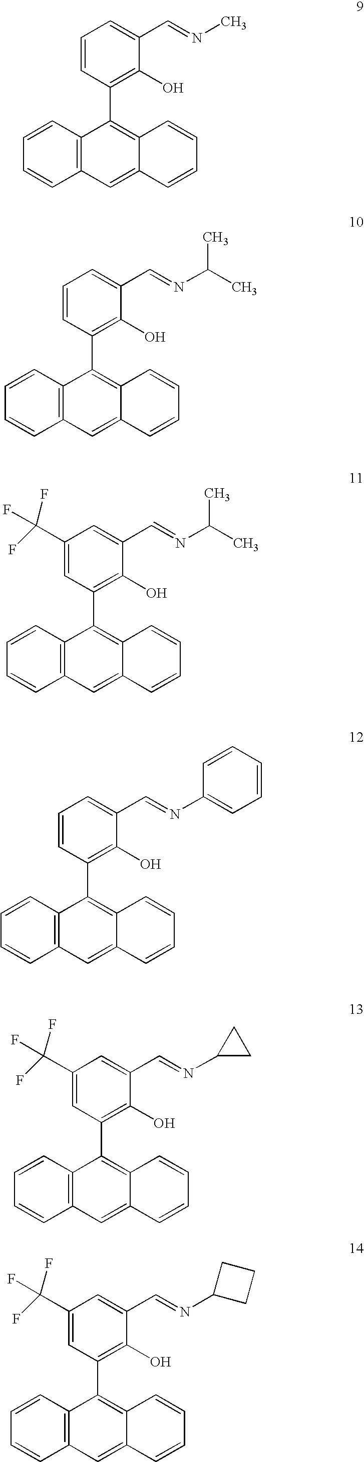

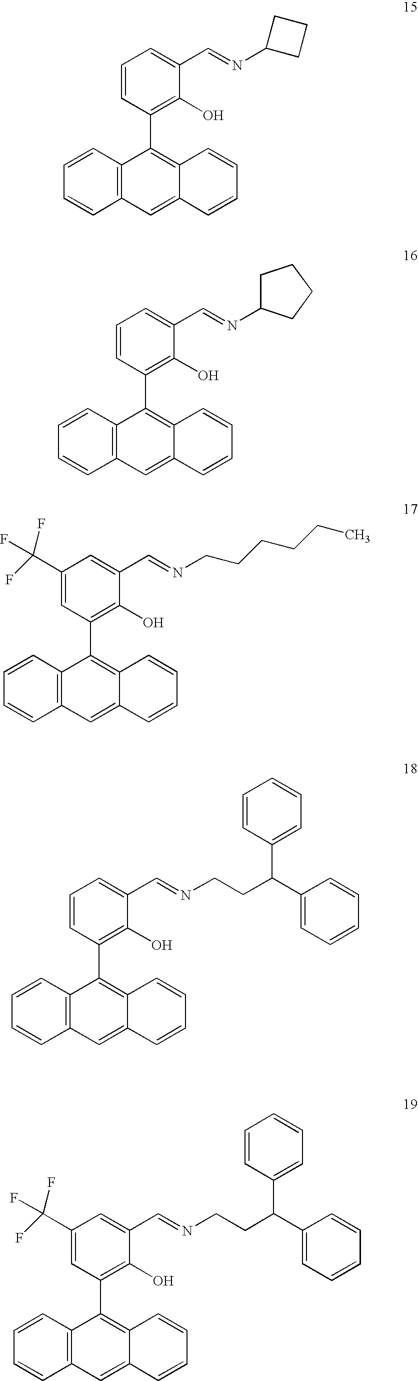

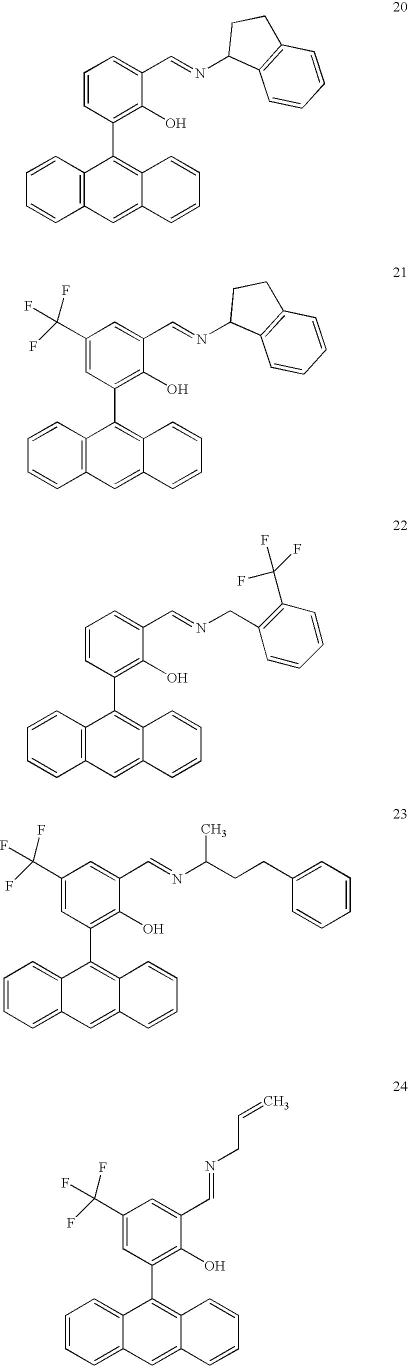

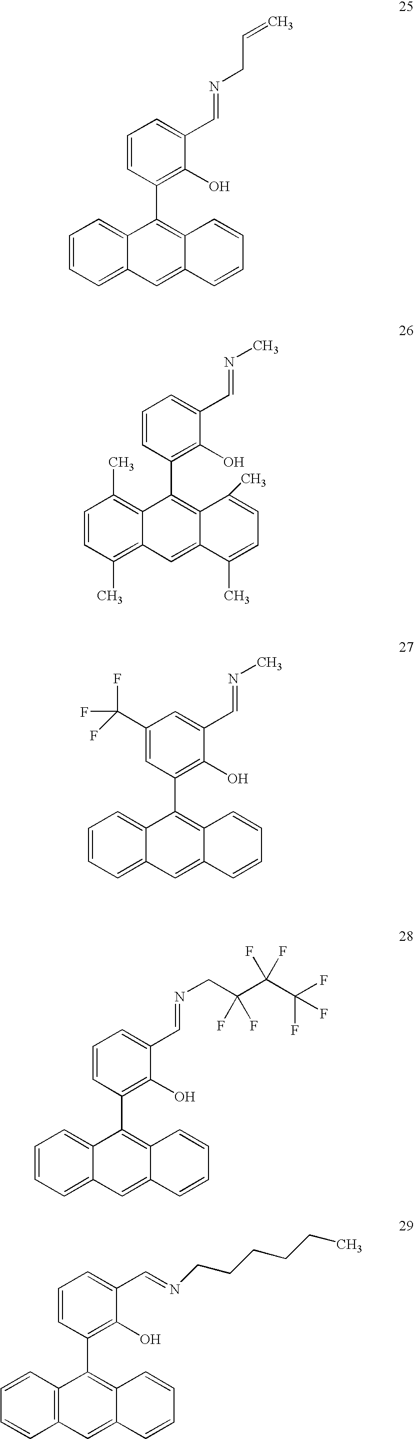

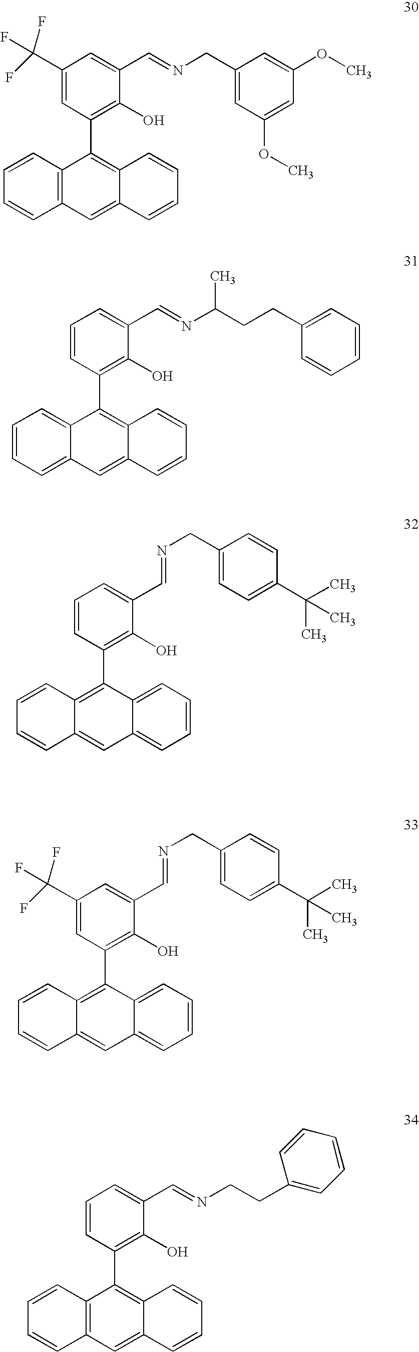

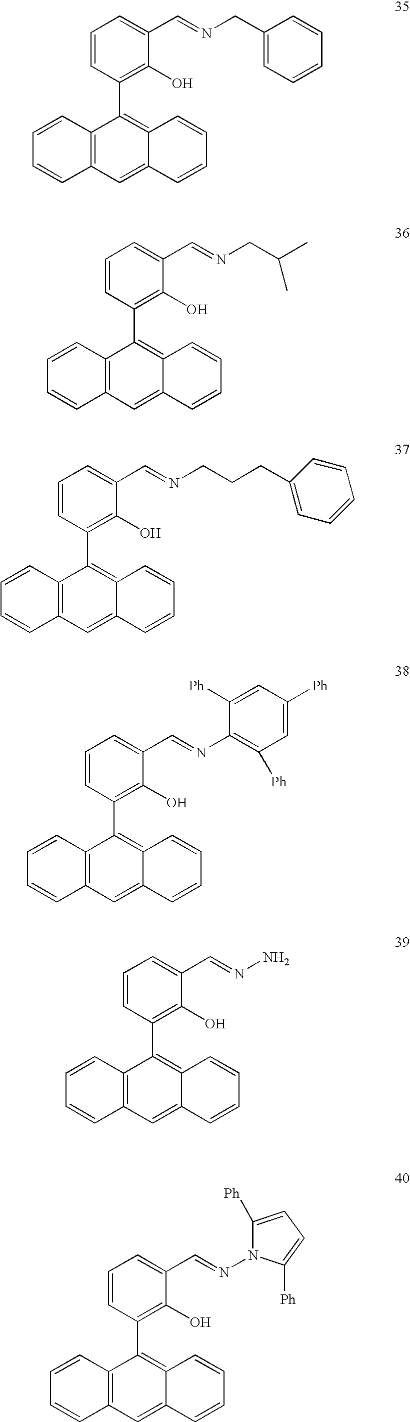

### Example 8—Polymerisation

Ethylene Polymerization Procedure:

The same general procedure was followed for all ligands and is described as follows: the ligand (5 μmol) was mixed with a solution of p-(tolyl)CrCl₂(THF)₃ (5 μmol in 1.5 mL toluene), and MAO was added (0.5 mL of a 1.8M solution in toluene, 180 eq.) The solution was then stirred under an ethylene atmosphere (1 bar) for 15 min; the activity was determined by polymer yield and the results are shown in the Table 2 below. The activities reported below are not optimized and higher activities would be expected under alternative (THF-free) test conditions (e.g. compare Example 8, Ligand 10 with Example 3, Ligand 10).

TABLE 2
Polymerisation results for Example 8

| | | Actvitiy |
|---|---|---|
| Ligand | Yield (mg) | g/mmol/h |
| 9 | 29.3 | 23.4 |
| 10 | 70.3 | 56.2 |
| 11 | 44.2 | 35.7 |
| 12 | 24.2 | 19.4 |
| 13 | 52.2 | 41.8 |
| 14 | 85.0 | 68.0 |
| 15 | 28.5 | 22.8 |
| 16 | 22.2 | 17.8 |
| 17 | 20.5 | 16.4 |
| 18 | 21.0 | 16.8 |
| 19 | 73.4 | 58.7 |
| 20 | 65.9 | 52.7 |
| 21 | 56.3 | 45.0 |
| 22 | 33.2 | 26.6 |
| 23 | 58.7 | 47.0 |
| 24 | 45.5 | 36.4 |
| 25 | 49.9 | 39.9 |
| 26 | 24.9 | 19.9 |
| 27 | 25.3 | 20.2 |
| 28 | 28.6 | 22.9 |
| 29 | 70.0 | 56.0 |
| 30 | 22.5 | 18.0 |
| 31 | 28.6 | 22.9 |
| 32 | 37.0 | 29.6 |
| 33 | 27.3 | 21.8 |

### Example 9—Polymerisation

Polymerisation catalysis data is presented in Table 3 below.

Activated Catalyst Solution Formation

A mixture of the required ligand (0.030 mmoles) and p-tolylCrCl₂.3THF (12.9 mg, 0.030 mmoles) were dissolved in 10 ml of dry degassed toluene and allowed to stir for 5 minutes, the initial yellow colour turning a brown yellow. The solvent was removed under vacuum and the brown residue dissolved in 26.2 ml of dry degassed toluene. The pro-catalyst was activated by the addition of MAO (3.8 ml, 1.6 M, 6.0 mmoles) and the slightly darker solution allowed to stir for 5 minutes.

### Examples 9A, 9B, 9D, 9E, 9F, 9H

A 5 ml aliquot (5 μmoles) of the activated catalyst solution was transferred to a Schlenk containing 95 ml of dry degassed toluene. In the case of example 5A, hexane was added via syringe at this point. The vessel was sealed and evacuated. The vessel was placed under 1 bar of ethylene pressure and allowed to react for 1 hour. The solution was deactivated by depressurising and addition of 100 ml of methanol containing 2 ml of dilute HCl. The polymer was recovered by filtration, washed with methanol and dried in a vacuum oven at 60° C. overnight.

### Examples 9C and 9G

A 1 litre Buchi reactor was prepared with 400 ml of isobutane at the required temperature and pressure of ethylene. The reactor was scavenged with 1.25 ml of 1.6 M MAO (2.0 mmoles) solution in toluene. A 5 ml aliquot (5 μmoles) of the activated catalyst solution was transferred to the reactor and the ethylene uptake monitored for the catalyst run. After 60 minutes the isobutane was vented and the polymer collected and dried in a vacuum oven at 60° C. overnight.

TABLE 3
Polymerisation catalysis for Examples 9A-9H

| | Example | | | | | | | |
|---|---|---|---|---|---|---|---|---|
| | 9A | 9B | 9C | 9D | 9E | 9F | 9G | 9H |
| Ligand | 15 | 15 | 15 | 16 | 18 | 18 | 18 | 5 |
| Cr:Al | 1:200 | 1:200 | 1:600 | 1:200 | 1:200 | 1:200 | 1:600 | 1:200 |
| Hexene (ml) | — | 2 | — | — | — | 2 | — | 2 |
| Temperature | 25 | 25 | 50 | 25 | 25 | 25 | 50 | 25 |
| (° C.) | | | | | | | | |
| Pressure (bar) | 1 | 1 | 4 | 1 | 1 | 1 | 4 | 1 |
| Yield (g) | 1.61^{a} | 0.57 | 13.22 | 1.12^{a} | 1.35 | 0.56 | 4.79 | 3.10 |
| Activity | 1288 | 912 | 661 | 920 | 270 | 112 | 239 | 619 |
| (g/mmol/h/b) | | | | | | | | |
| Mₙ | 30000 | — | — | 26000 | 20000 | 36000 | 42000 | 1100 |
| M_{w} | 75000 | — | — | 85000 | 644000 | 1476000 | 540000 | 1700 |
| M_{w}/Mₙ | 2.5 | — | — | 3.2 | 31.9 | 41.4 | 12.8 | 1.6 |
| Mₚₖ | 54000 | — | — | 61000 | 222000 | 1704000 | 483000 | 1000 |
| Butyls | — | 0.7 | — | — | — | — | 1.1 | 2.3 |
| (/1000Cs) | | | | | | | | |

^{a}run time was 15 min

Standard conditions were used:

Examples 9A, 9B, 9D, 9E, 9F, 9H: 5 μmoles Cr, 1 bar ethylene, 100 mls of toluene for 60 mins.

Examples 9C, 9G: 5 μmoles Cr, 50° C., 400 mls isobutane, 4 bar with 2.0 mmoles of MAO as a scavenger, 60 minutes.

### Example 10—Preparation of Supported Catalyst

Preimpregnation of Support with Activator Compound

ES70X (calcined at 250° C., 10 hours under flowing nitrogen) was placed in a 250 ml round bottomed flask and toluene added (50 mL). MAO was added to the silica at room temperature (62 mL, 1.78M MAO in toluene) and the flask heated to 80° C. for 1 hour with constant stirring. Drying of the support was at 80° under vacuum.

Preparation of Supported Catalyst

A mixture of N-isopropyl 3-(9-anthracenyl)-2-hydroxybenzyaldimine (Example 1) (30 mg, 0.088 mmoles) and p-tolylCrCl₂.(THF)₃ (38 mg, 0.088 mmoles) were dissolved in 20 mL of dry degassed toluene and allowed to stir for 30 minutes, the initial yellow colour turned a brown yellow. The resultant slurry was added to a toluene (10 mL) slurry of the activator impregnated support (3 g, prepared as described above) at room temperature. The mixture was occasionally shaken over a 30 minute period. The supernatant solution was removed and the silica/MAO/Fe complex dried under vacuum at 25° C.

### Example 11—Low Pressure Ethylene Polymerisation Test using a Supported Catalyst

300 mg of supported catalyst (from Example 10) was transferred to a reaction vessel containing 20 mls of dry degassed toluene and 0.7 mls of triisobutyl aluminium (1M in hexanes). The vessel was sealed and evacuated. The vessel was placed under 1 Bar of ethylene pressure and allowed to react for 60 minutes. The solution was deactivated by depressurising and addition of methanol containing 10% v/v dilute HCl. The polymer was recovered by filtration, washed with acetone and dried in a vacuum oven at 60° C. overnight. Isolated polymer yield=0.847 g (130 g/mmol[Cr].h.b)

### Example 12—Elevated Pressure Ethylene Polymerisation Test using Supported Catalyst

A 1L reactor was heated under flowing nitrogen for 1.5 hours at 85° C. before being cooled to 35° C. Isobutane (500 ml) followed by triisobutyl aluminium (3 ml of 1M in hexanes) was added to the reactor. The reactor was sealed and heated to 80° C. for 1 hour prior to being cooled to 50° C. Ethylene was added to give a 10 bar rise in total pressure. The supported catalyst (from Example 10), prepared above, (0.38 g) was weighed into a schlenk, slurried in toluene (10 ml) then injected into the reactor. Constant reactor pressure and temperature were controlled during the test. Polymerisation was allowed to continue for 60 minutes. Isolated polymer yield=14.57 g (133 g/mmol[Cr].h.b)

### Example 13 (Comparative)—Ethylene Polymerisation

Ethylene polymerisation was conducted using the two catalysts shown below, under the conditions indicated. Comparison between the complex of Example 5A and that of Example 11 of WO 01/44324 shows the effect on catalyst activity of the large triptycene group at position R¹ compared with tBu.

| SOURCE | CATALYST | ACTIVITY |
|---|---|---|
| WO 01/44324 (Example 11) | 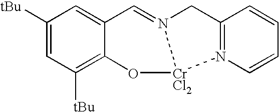 | <1 g/mmol · h^{a} |
| Example 5A | 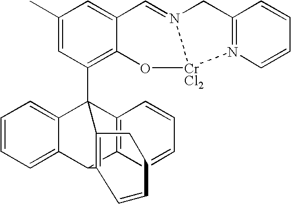 | 1574 g/mmol · h^{b} |

^{a}Over 16h at 3.45 Mpa pressure, using 0.02 mmol catalyst, 0.056 g PE isolated
^{b}Over 1 h at 1 bar pressure, using 0.005 mmol catalyst, 7.87 g PE isolated

### Example 12 (Comparative)

Ligand 41 below was tested for ethylene polymerisation under the same conditions as in Example 8. Ligand 41 was disclosed in WO 98/42664 and was shown to be highly active for ethylene polymerisation when coordinated to Ni. However this example shows that the same ligand gives a very low activity catalyst when coordinated to Cr, especially compared with ligands 10 and 12 in Example 8 for example.

| Example | CATALYST | ACTIVITY |
|---|---|---|
| Ligand 41 | 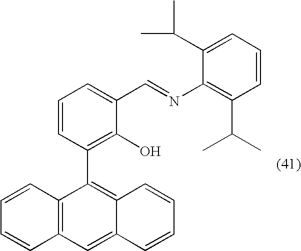 | 3.6 g/mmol · h |
| Example 8, ligand 12 | 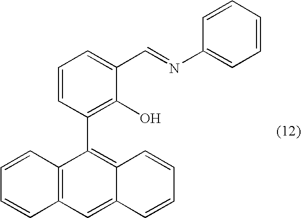 | 19.4 g/mmol · h |
| Example 8, ligand 10 | 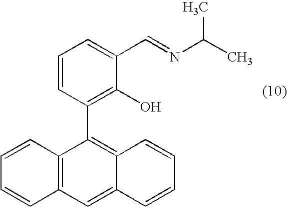 | 56.2 g/mmol · h |

1. Complex having the formula (I) 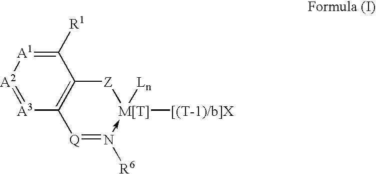
wherein M is a Group 6 metal and T is its oxidation state; X represents an atom or group covalently or ionically bonded to M; b is the valency of the atom or group X; L is a group datively bound to M, and n is from 0 to 4; Z is oxygen or sulphur; A¹ to A³ are each independently N or P or CR, with proviso that at least one is CR; R¹ is a polycyclic hydrocarbyl group; Q is CR⁵, PR⁵R⁷ or N; each R and R⁵ to R⁷ are all independently selected from hydrogen, halogen, hydrocarbyl, substituted hydrocarbyl, heterohydrocarbyl, substituted heterohydrocarbyl or Sir′₃ where each R′ is independently selected from hydrogen, halogen, hydrocarbyl, substituted hydrocarbyl, heterohydrocarbyl, substituted heterohydrocarbyl, and any two or more of each R and R⁵ to R⁷ may be linked to form cyclic substituents.

2. Complex according to claim 1 having the formula (II) 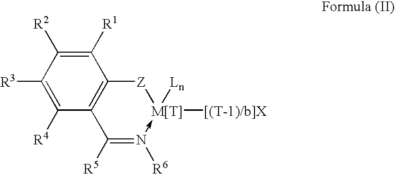
wherein R¹, R⁵, R⁶, M, T, L, n, b, X and Z are as defined above, an R² to R⁴ are each independently selected from hydrogen, halogen, hydrocarbyl, substituted hydrocarbyl, heterohydrocarbyl, substituted heterohydrocarbyl or Sir′₃ where each R′ is independently selected from hydrogen, halogen, hydrocarbyl, substituted hydrocarbyl, heterohydrocarbyl, substituted heterohydrocarbyl, and any two or more of R² to R⁶ may be linked to form cyclic substituents.

3. Complex according to any preceding claim, wherein R¹ is anthracenyl, naphthyl or triptycenyl, all of which may optionally be substituted, preferably with C₁-C₆ alkyl groups.

4. Complex according to claim 3, wherein R¹ has the structure A or B:

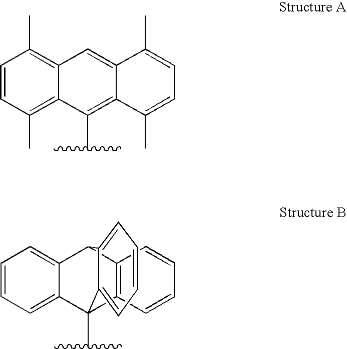

5. Complex according to any preceding claim, wherein M is Cr, preferably Cr(III).

6. Compound having the formula (III) 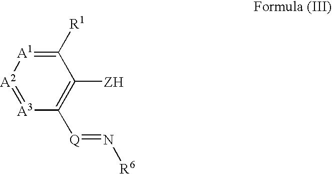
wherein Z is oxygen or sulphur, A¹ to A³ are each independently N or P or CR, with the proviso that at least one is CR; Q is CR⁵, PR⁵R⁷ or N; each R and R⁵ to R⁷ are all independently selected from hydrogen, halogen, hydrocarbyl, substituted hydrocarbyl, heterohydrocarbyl, substituted heterohydrocarbyl or SiR′₃ where each R′ is independently selected from hydrogen, halogen, hydrocarbyl, substituted hydrocarbyl, heterohydrocarbyl, substituted heterohydrocarbyl, and any two or more of each R and R⁵ to R⁷ may be linked to form cyclic substituents; and R¹ has the structure B:

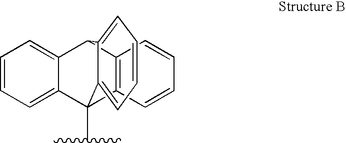

7. Compound according to claim 6 having the formula (IV 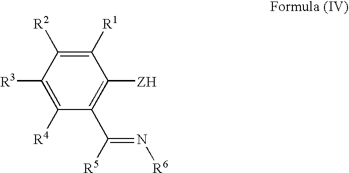
wherein R¹, R⁵, R⁶ and Z are as defined above, and R² to R⁴ are each independently selected from hydrogen, halogen, hydrocarbyl, substituted hydrocarbyl, heterohydrocarbyl, substituted heterohydrocarbyl or Sir′₃ where each R′ is independently selected from hydrogen, halogen, hydrocarbyl, substituted hydrocarbyl, heterohydrocarbyl, substituted heterohydrocarbyl, and any two or more of R² to R⁶ may be linked to form cyclic substituents.

8. Complex or compound according to any preceding claim, wherein R⁶ is C₁-C₆ alkyl or alkenyl, or C₁-C₆ haloalkyl or haloalkenyl; preferably isopropyl.

9. Complex or compound according to any of claims 1 to 7, wherein R⁶ is C₁-C₂₄, preferably C₁-C₁₂ aryl, aralkyl or alkaryl, which may optionally be substituted with halo, alkoxy, amino or nitro.

10. Complex or compound according to any of claims 1 to 7, wherein R⁵ is an amino group, optionally substituted.

11. Complex or compound according to any of claims 1 to 7, wherein R⁶ is —R″-D-R⁸R⁹, where R″ is an optionally substituted hydrocarbyl bridging group, D is N, S, P or O, and R⁸ and R⁹ are independently selected from hydrogen, halogen, hydrocarbyl, substituted hydrocarbyl, heterohydrocarbyl, substituted heterohydrocarbyl or SiR′₃ where each R′ is independently selected from hydrogen, halogen, hydrocarbyl, substituted hydrocarbyl, heterohydrocarbyl, substituted heterohydrocarbyl, and any two or more of the substituents on R″ and R⁸ or R⁹ may be linked to form cyclic substituents, as may any of the substituents on R″ and R⁵, with the proviso that if D is attached to R″ or R⁸ via a double bond or is O or S, R⁹ does not exist.

12. Complex or compound according to claim 11, wherein D is N and preferably forms part of a pyridinyl ring.

13. Complex or compound according to claim 11, wherein R⁶ is one of the following:

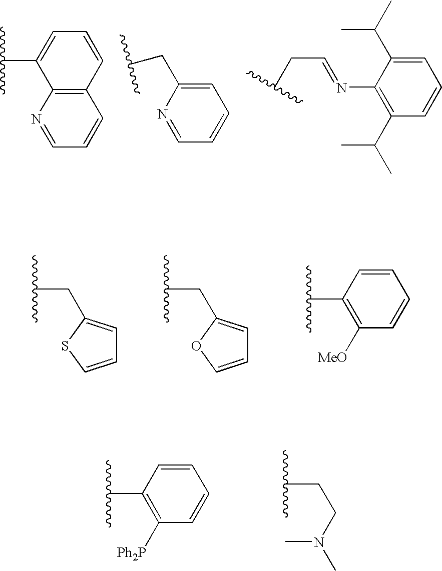

14. Complex or compound according to claim 11, wherein R⁵ is joined to a substituent on R″ to form a heterocyclic ring containing the N between R⁵ and R″.

15. Complex according to any preceding claim, wherein the atom or group represented by X in the compounds of Formula (I) or (II) is selected from halide, sulphate, nitrate, thiolate, thiocarboxylate, BF₄⁻, PF₆⁻, hydride, hydrocarbyloxide, carboxylate, hydrocarbyl, substituted hydrocarbyl and heterohydrocarbyl, or β-diketonates.

16. Complex according to any preceding claim, wherein the Group L is an ether, preferably tetrahydrofuran or diethylether, or an alcohol, preferably ethanol or butanol, or a primary, secondary or tertiary amine, or a phosphine.

17. Polymerisation catalyst comprising
(a) a complex as defined in any one of claims 1 to 5 or 8 to 14, and
(b) an effective amount of at least one activator compound.

18. Polymerisation catalyst comprising
(a) a compound as defined in any of claims 6 to 16,
(b) an effective amount of at least one activator compound and
(c) a source of a Group VI metal.

19. Catalyst according to claim 17 or 18, wherein the activator compound is selected from organoaluminium compounds of the formula AlR₃, where each R is independently C₁-C₁₂ alkyl or halo, and hydrocarbylboron compounds.

20. Catalyst according to claim 19, wherein the activator is selected from trimethylaluminium (TMA), triethylaluminium (TEA), tri-isobutylaluminium (TIBA), tri-n-octylaluminium, methylaluminium dichloride, ethylaluminium dichloride, dimethylaluminium chloride, diethylaluminium chloride, ethylaluminiumsesquichloride, methylaluminiumsesquichloride, alumoxanes, boroxines, trimethylboron, triethylboron, dimethylphenylammoniumtetra(phenyl)borate, trityltetra(phenyl)borate, triphenylboron, dimethylphenylammonium tetra(pentafluorophenyl)borate, sodium tetrakis[(bis-3,5-trifluoromethyl)phenyl]borate, H⁺(OEt₂)[(bis-3,5-trifluoromethyl)phenyl]borate, trityltetra(pentafluorophenyl)borate and tris(pentafluorophenyl) boron.

21. Catalyst according to any one of claims 17 to 20, further comprising a neutral Lewis base.

22. Catalyst according to claim 21 wherein the neutral Lewis base is selected from alkenes (other than 1-olefins) or alkynes, primary, secondary and tertiary amines, amides, phosphoramides, phosphines, phosphites, ethers, thioethers, nitriles, esters, ketones, aldehydes, carbon monoxide and carbon dioxide, sulphoxides, sulphones and boroxines.

23. Catalyst according to any one of claims 17 to 22 which is supported on a support material comprising silica, alumina, MgCl₂ or zirconia, or on a polymer or prepolymer comprising polyethylene, polypropylene, polystyrene, or poly(aminostyrene).

24. Catalyst according to any one of claims 17 to 23 which comprises more than one complex as defined in any of claims 1 to 16 or compound as defined in any of claims 6 to 16.

25. Catalyst according to any one of claims 17 to 23 which comprises a complex or compound as defined in any of claims 1 to 16 plus a further catalyst suitable for the polymerisation of 1-olefins, preferably a Ziegler-Natta catalyst system, metallocene-based catalyst, monocyclopentadienyl- or constrained geometry based catalyst, or heat activated supported chromium oxide catalyst.

26. Compound having the formula (V) 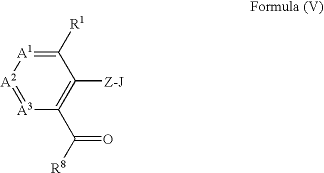
wherein Z is oxygen or sulphur, J is H or an alkali metal; A¹ to A³ are each independently N or P or CR, with the proviso that at least one is CR; R⁸ is selected from hydrogen, halogen, hydrocarbyl, substituted hydrocarbyl, heterohydrocarbyl, substituted heterohydrocarbyl or SiR′₃ where each R′ is independently selected from hydrogen, halogen, hydrocarbyl, substituted hydrocarbyl, heterohydrocarbyl and substituted heterohydrocarbyl; and R¹ has the structure B:

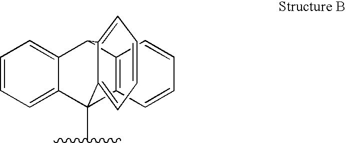

27. Compound according to claim 26 wherein A¹ to A³ are each independently CR, and R⁸ is hydrogen.

28. Process for the polymerisation or copolymerisation of 1-olefins, comprising contacting a monomeric olefin under polymerisation conditions with a complex or catalyst as defined in any of claims 1 to 5 or 8 to 25.

29. Process according to claim 28 comprising the steps of:
a) preparing a prepolymer-based catalyst by contacting one or more 1-olefins with a catalyst, and
b) contacting the prepolymer-based catalyst with one or more 1-olefins, wherein the catalyst is as defined in any of claims 17 to 25.

30. Process according to claim 28 or 29 wherein the polymerisation is conducted in the presence of hydrogen as a molecular weight modifier.

31. Process according to any one of claims 28 to 30 wherein the polymerisation conditions are solution phase, slurry phase or gas phase.

32. Process according to claim 31 wherein the polymerisation is conducted under gas phase fluidised bed conditions.

33. Process according to claim 31 wherein the polymerisation is conducted in slurry phase in an autoclave or continuous loop reactor.

34. Use of a complex as defined in any of claims 1 to 5 or 8 to 16 as a catalyst for the polymerisation of 1-olefins.
